(19) United States
(12) Patent Application Publication
(10) Pub. No.: US 2013/0314309 A1
(43) Pub. Date: Nov. 28, 2013

(54) DISPLAY DEVICE

(71) Applicant: Nobuhiro Kuwabara, Osaka-shi (JP)

(72) Inventor: Nobuhiro Kuwabara, Osaka-shi (JP)

(73) Assignee: Sharp Kabushiki Kaisha, Osaka-shi, Osaka (JP)

(21) Appl. No.: 13/982,266

(22) PCT Filed: Jan. 23, 2012
(86) PCT No.: PCT/JP2012/051344

§ 371 Date: Jul. 28, 2013

(30) Foreign Application Priority Data
Jan. 28, 2011 (JP) 2011-015945

(51) Int. Cl. G09G 3/36

(52) U.S. Cl. CPC G09G 3/3677; G09G 3/3614; G09G 3/3648
USPC 345/92

(57) ABSTRACT

The present invention provides a display device in which a lateral crosstalk can be suppressed with a simple configuration. A display panel of a liquid crystal display device includes an output-end-side TFT provided on an output end side of a scanning signal line. Auxiliary capacitance lines adjacent to each other are connected via the output-end-side TFT. When a scanning signal line is in a selection state, a corresponding output-end-side TFT enters a conduction state, so that the auxiliary capacitance line and its preceding auxiliary capacitance line are connected to each other. At this time, impedance seen from a position where a potential fluctuation occurs in the auxiliary capacitance line is seemingly reduced more than that in the conventional technique. Consequently, time Tret until potential of the auxiliary capacitance line which fluctuated at the time of writing a data signal recovers to the original potential becomes shorter than that in the conventional technique.

### CROSS REFERENCE TO RELATED APPLICATION

This application claims the priority of Japanese Patent Application No. 2011-015945, filed on Jan. 28, 2011 in the JIPO (Japanese Intellectual Property Office). Further, this application is the National Phase application of International Application No. PCT/JP2012/051344 filed on Jan. 23, 2012, which designates the United States and was published in Japanese.

### TECHNICAL FIELD

The present invention relates to a display device and, more particularly, to an active matrix-type display device using a switching element such as a thin film transistor.

### BACKGROUND ART

In recent years, an active matrix-type display device such as a liquid crystal display device or an organic EL display device is widely spread. Particularly, a liquid crystal display device in which a switching element such as a thin film transistor (TFT) is provided for each pixel circuit receives attention since it can obtain a display image with suppressed crosstalk even when the number of pixels increases.

Such an active matrix-type liquid crystal display device is conventionally requested to realize lower power consumption. As one of methods of realizing lower power consumption, there is known a method of performing polarity inversion driving by changing the potential of a corresponding auxiliary capacitance line after completion of a selection period of each scanning signal line. In such a driving method, a large voltage can be applied to a liquid crystal layer with small data signal amplitude, so that the power consumption can be reduced. Such a driving method is disclosed in, for example, Patent Documents 1 to 3.

However, in a liquid crystal display device performing polarity inversion driving by changing the potential of an auxiliary capacitance line, an auxiliary capacitance is formed by a pixel electrode and an auxiliary capacitance line, so that a potential fluctuation in a pixel electrode which occurs at the time of writing a data signal to the pixel electrode is transmitted to the auxiliary capacitance line via the auxiliary capacitance. Consequently, the potential in the auxiliary capacitance line fluctuates and, as a result, the pixel potential becomes a value different from the potential to be held originally. Due to this, the conventional liquid crystal display device using the method of performing the polarity inversion driving by changing the potential of a corresponding auxiliary capacitance line after completion of the selection period of each scanning signal line has a problem such that a crosstalk in the lateral direction (hereinbelow, called “lateral crosstalk”) occurs and display quality deteriorates.

As a method of solving such a lateral crosstalk, Patent Document 4 discloses a display device in which an auxiliary capacitance line drive circuit is provided on each of both end sides of an auxiliary capacitance line and, as described above, after completion of selection period of each scanning signal line, polarity inversion driving is performed by changing the potential of a corresponding auxiliary capacitance line. By supplying potential from both end sides of the auxiliary capacitance line, thus, apparent impedance of the auxiliary capacitance line can be decreased. Consequently, even in the case where the potential in the auxiliary capacitance line fluctuates, the fluctuation can be suppressed. Patent Document 5 discloses a display device in which an auxiliary capacitance for voltage stabilization is provided for each of auxiliary capacitance lines. By the auxiliary capacitance for voltage stabilization, noise mixed in each of the auxiliary capacitances can be absorbed. Consequently, the potential fluctuation in the auxiliary capacitance line can be suppressed. Except for the above, means for suppressing deterioration in the display quality related to the present invention and the like are disclosed in, for example, Patent Documents 6 to 8.

### PRIOR ART DOCUMENTS

### Patent Documents

[Patent Document 1] Japanese Patent Application Laid-Open No. 2006-220947
[Patent Document 2] Japanese Patent Application Laid-Open No. 2002-196358
[Patent Document 3] Japanese Patent Application Laid-Open No. 2007-47220
[Patent Document 4] Japanese Patent Application Laid-Open No. 2005-62395
[Patent Document 5] Japanese Patent Application Laid-Open No. 2003-202592
[Patent Document 6] Japanese Patent Application Laid-Open No. H08-234239
[Patent Document 7] Japanese Patent Application Laid-Open No. H10-282524
[Patent Document 8] Japanese Patent Application Laid-Open No. 2008-292787

### SUMMARY OF THE INVENTION

### Problems to be Solved by the Invention

However, in the configuration of the display device described in the Patent Document 4, the auxiliary capacitance line drive circuits are necessary on both end sides of the auxiliary capacitance line, so that the circuit scale becomes large. Due to this, it is difficult to narrow a frame and the power consumption increases. Further, since the potential is supplied from the both end sides of an auxiliary capacitance line, there is the possibility that, due to increase in the amplitude of the auxiliary capacitance potential, power consumption increases. It is therefore necessary to adjust timings of supplying the potential from the both end sides of the auxiliary capacitance line.

In the configuration of the display device described in the Patent Document 5, to sufficiently obtain the above-described effects, a large auxiliary capacitance for voltage stabilization is necessary. Consequently, a wide region for providing the auxiliary capacitance for voltage stabilization is necessary, and the aperture ratio decreases. Although the Patent Document 5 discloses an example of forming the auxiliary capacitance for voltage stabilization by using a common auxiliary capacitance line, it also needs a wider region, and the aperture ratio decreases.

Therefore, an object of the present invention is to provide a display device in which a lateral crosstalk can be suppressed with a simple configuration.

### Solution to the Problems

A first aspect of the present invention relates to a display device comprising:

a plurality of data signal lines to which a plurality of data signals representing an image to be displayed are applied, respectively;

scanning signal lines crossing the plurality of data signal lines and selectively driven by applying a plurality of scanning signals, respectively;

a plurality of pixel circuits disposed in a matrix in correspondence with the respective intersections of the plurality of data signal lines and the plurality of scanning signal lines;

a plurality of auxiliary capacitance lines disposed along the plurality of scanning signal lines, respectively;

an auxiliary capacitance line drive circuit for applying a plurality of auxiliary capacitance signals for driving the plurality of auxiliary capacitance lines independently of one another to the plurality of auxiliary capacitance lines, respectively; and

an output-end-side switching element provided on an output end side of each of the scanning signal lines,

wherein each of the pixel circuits includes

a pixel switching element which enters a conduction state when the scanning signal line passing a corresponding intersection is in a selection state and enters a blocking state when the scanning signal line is in a non-selection state,

a pixel electrode connected to a data signal line passing the corresponding intersection via the pixel switching element,

a common electrode provided commonly to the plurality of pixel circuits, and

an auxiliary capacitance formed between the pixel electrode and an auxiliary capacitance line disposed along a scanning signal line passing the corresponding intersection,

after the scanning signal line is switched from a selection state to a non-selection state, the auxiliary capacitance line drive circuit changes a potential of an auxiliary capacitance signal to be applied to an auxiliary capacitance line disposed along the scanning signal line,

an auxiliary capacitance line disposed along a scanning signal line corresponding to each of output-end-side switching elements and an auxiliary capacitance line disposed along a scanning signal line preceding to the scanning signal line in a scanning direction in the plurality of scanning signal lines are connected to each other via said each of output-end-side switching elements on an output end side, and

each of output-end-side switching elements is controlled to enter a conduction state when a scanning signal line corresponding to said each of output-end-side switching elements is in the selection state and to enter a blocking state when the scanning signal line is in the non-selection state in accordance with a predetermined signal.

A second aspect of the present invention is characterized in that, in the first aspect of the present invention, the polarity of the plurality of data signals inverts every horizontal period, and

auxiliary capacitance signals applied to auxiliary capacitance lines connected to each other via each of output-end-side switching elements have a same potential when said each of output-end-side switching elements is in a conduction state.

A third aspect of the present invention is characterized in that, in the second aspect of the present invention, a control terminal of each output-end-side switching element is connected to a corresponding scanning signal line,

one of conduction terminals of each output-end-side switching element is connected to an auxiliary capacitance line disposed along the corresponding scanning signal line, and

the other conduction terminal of each output-end-side switching element is connected to an auxiliary capacitance line disposed along a scanning signal line preceding to the corresponding scanning signal line in a scanning direction of the plurality of scanning signal lines.

A fourth aspect of the present invention is characterized in that, in the second aspect of the present invention, the scanning direction of the plurality of scanning signal lines can be switched between a first direction and a second direction as a direction opposite to the first direction.

A fifth aspect of the present invention is characterized in that, in the fourth aspect of the present invention, a control terminal of each output-end-side switching element is selectively connected to a corresponding scanning signal line or a scanning signal line preceding to the corresponding scanning signal line in the first direction,

one of conduction terminals of each output-end-side switching element is connected to an auxiliary capacitance line disposed along a corresponding scanning signal line, and

the other conduction terminal of each output-end-side switching element is connected to an auxiliary capacitance line disposed along the scanning signal line preceding to the corresponding scanning signal line in the first direction.

A sixth aspect of the present invention is characterized in that, in the fifth aspect of the present invention, further comprising a change-over switch provided in correspondence with each scanning signal line,

wherein one of switching terminals of each change-over switch is connected to a corresponding scanning signal line,

the other switching terminal of each change-over switch is connected to a scanning signal line preceding to the corresponding scanning signal line in the first direction,

a common terminal of each change-over switch is connected to a control terminal of an output-end-side switching element provided on the output-end-side of the corresponding scanning signal line, and

each change-over switch is controlled to select the one of the switching terminals when the scanning direction of the plurality of scanning signal lines is the first direction and to select the other switching terminal when the scanning direction of the plurality of scanning signal lines is the second direction.

A seventh aspect of the present invention is characterized in that, in the second aspect of the present invention, further comprising an input-end-side switching element provided on an input end side of each scanning signal line,

wherein an auxiliary capacitance line disposed along a scanning signal line corresponding to each of input-end-side switching elements and an auxiliary capacitance line disposed along a scanning signal line preceding to the scanning signal line in a scanning direction of the plurality of scanning signal lines are connected to each other via said each of input-end-side switching elements on an input end side.

### Effects of the Invention

According to the first aspect of the present invention, at the time of selecting a scanning signal line, an auxiliary capacitance line disposed along the scanning signal line and an auxiliary capacitance line disposed along a scanning signal line which is preceding to the scanning signal line in a scanning direction are connected to each other, so that apparent impedance in the auxiliary capacitance line is reduced as compared with that in the conventional technique. Therefore, the time until the potential of the auxiliary capacitance line fluctuated at the time of writing a data signal recovers to the original potential becomes shorter than that in the conventional technique. Thus, no fluctuation occurs in the pixel potential due to the potential fluctuation in the auxiliary capacitance line. To realize the present invention, it is sufficient to add an output-end-side switching element on the output end side of each scanning signal line. Therefore, a lateral crosstalk can be suppressed with the simple configuration.

According to the second aspect of the present invention, in the case of performing driving by inverting the polarity of a plurality of data signals every horizontal period, effects similar to those of the first aspect of the present invention can be produced.

According to the third aspect of the present invention, it is unnecessary to separately use a signal for controlling the output-end-side switching element. Consequently, effects similar to those of the second aspect of the present invention can be produced with a simpler configuration.

According to the fourth aspect of the present invention, in the case where the scanning direction of the scanning signal line can be switched, effects similar to those of the second aspect of the present invention can be produced.

According to the fifth aspect of the present invention, it is unnecessary to separately use a signal for controlling the output-end-side switching element. Consequently, effects similar to those of the fourth aspect of the present invention can be produced with a simpler configuration.

According to the sixth aspect of the present invention, by providing a change-over switch in correspondence with each scanning signal line, effects similar to those of the fifth aspect of the present invention can be produced.

According to the seventh aspect of the present invention, regardless of a position where a potential fluctuation occurs in an auxiliary capacitance line, the apparent impedance in the auxiliary capacitance line is reduced sufficiently as compared with that in the conventional technique. Consequently, regardless of a position where a potential fluctuation occurs in an auxiliary capacitance line, time until the potential of the auxiliary capacitance line fluctuated at the time of writing a data signal recovers to the original potential becomes sufficiently shorter than that in the conventional technique. To realize the embodiment, it is sufficient to add an input-end-side switching element on the input end side of each scanning signal line in the second aspect of the present invention. Therefore, a lateral crosstalk can be reliably suppressed with the simple configuration.

### BRIEF DESCRIPTION OF THE DRAWINGS

FIG. 1 is a circuit diagram illustrating an electrical configuration of a liquid crystal display device according to a first embodiment of the present invention.

FIG. 2 is a circuit diagram illustrating an electrical configuration of an auxiliary capacitance line drive circuit in the first embodiment.

FIGS. 3(A) to 3(G) are voltage waveform charts for explaining the operation of the liquid crystal display device in the first embodiment.

FIG. 4(A) is a voltage waveform chart resulting from enlarging a part RB surrounded by a broken line in FIG. 3(G), FIG. 4(B) is a voltage waveform chart of a potential in an auxiliary capacitance line in a conventional liquid crystal display device resulting from enlarging a part RA surrounded by a broken line in FIG. 3(E), and FIG. 4(C) is a voltage waveform chart of a potential of an auxiliary capacitance line in the first embodiment resulting from enlarging the part RA surrounded by the broken line in FIG. 3(E).

FIG. 5 is an equivalent circuit diagram of an auxiliary capacitance line in the first embodiment.

FIG. 6 is an equivalent circuit diagram of the auxiliary capacitance line in the first embodiment.

FIG. 7 is a diagram illustrating an example of displaying a predetermined display pattern in the first embodiment.

FIGS. 8(A) to 8(D) are voltage waveform charts of parts corresponding to a scanning signal line GL(n) and an auxiliary capacitance line CSL(n) in the display image illustrated in FIG. 7.

FIGS. 9(A) to 9(D) are voltage waveform charts of parts corresponding to a scanning signal line GL(p) and an auxiliary capacitance line CSL(p) in the display image illustrated in FIG. 7.

FIG. 10 is a circuit diagram illustrating an electrical configuration of a liquid crystal display device according to a second embodiment of the present invention.

FIG. 11 is a circuit diagram illustrating an electrical configuration of a liquid crystal display device according to a third embodiment of the present invention.

FIG. 12 is a circuit diagram illustrating an electrical configuration of a liquid crystal display device according to a fourth embodiment of the present invention.

FIG. 13 is an equivalent circuit diagram of an auxiliary capacitance line in the fourth embodiment.

FIG. 14 is a circuit diagram illustrating an electrical configuration of a liquid crystal display device related to a basic examination of the present invention.

FIG. 15 is a circuit diagram illustrating an electrical configuration of a pixel circuit in the basic examination and the first embodiment.

FIGS. 16(A) to 16(E) are voltage waveform charts for explaining operation of the liquid crystal display device in the basic examination and the first embodiment.

FIG. 17 is an equivalent circuit diagram of an auxiliary capacitance line.

FIGS. 18(A) and 18(B) are voltage waveform charts of a case where recovery time is shorter than a write period; and FIG. 18(A) is a voltage waveform chart of the potential of an auxiliary capacitance line resulting from enlarging a part RA surrounded by the broken line in FIG. 16(C) and FIG. 18(B) is a voltage waveform chart of the pixel potential resulting from enlarging a part RB surrounded by the broken line in FIG. 16(E).

FIGS. 19(A) and 19(B) are voltage waveform charts of a case where recovery time is longer than a write period, and FIG. 19(A) is a voltage waveform chart of the potential of the auxiliary capacitance line resulting from enlarging the part RA surrounded by the broken line in FIG. 16(C) and FIG. 19(B) is a voltage waveform chart of the pixel potential resulting from enlarging the part RB surrounded by the broken line in FIG. 16(E).

FIGS. 20(A) to 20(D) are voltage waveform charts for explaining the operation of the liquid crystal display device related to the basic examination according to the magnitude of a potential fluctuation amount ΔV.

FIG. 21 is a diagram illustrating an example of displaying a predetermined display pattern in the liquid crystal display device relate to the basic examination.

FIGS. 22(A) to 22(D) are voltage waveform charts of parts corresponding to the scanning signal line GL(n) and the auxiliary capacitance line CSL(n) in the display image illustrated in FIG. 21.

FIGS. 23(A) to 23(D) are voltage waveform charts of parts corresponding to the scanning signal line GL(p) and the auxiliary capacitance line CSL(p) in the display image illustrated in FIG. 21.

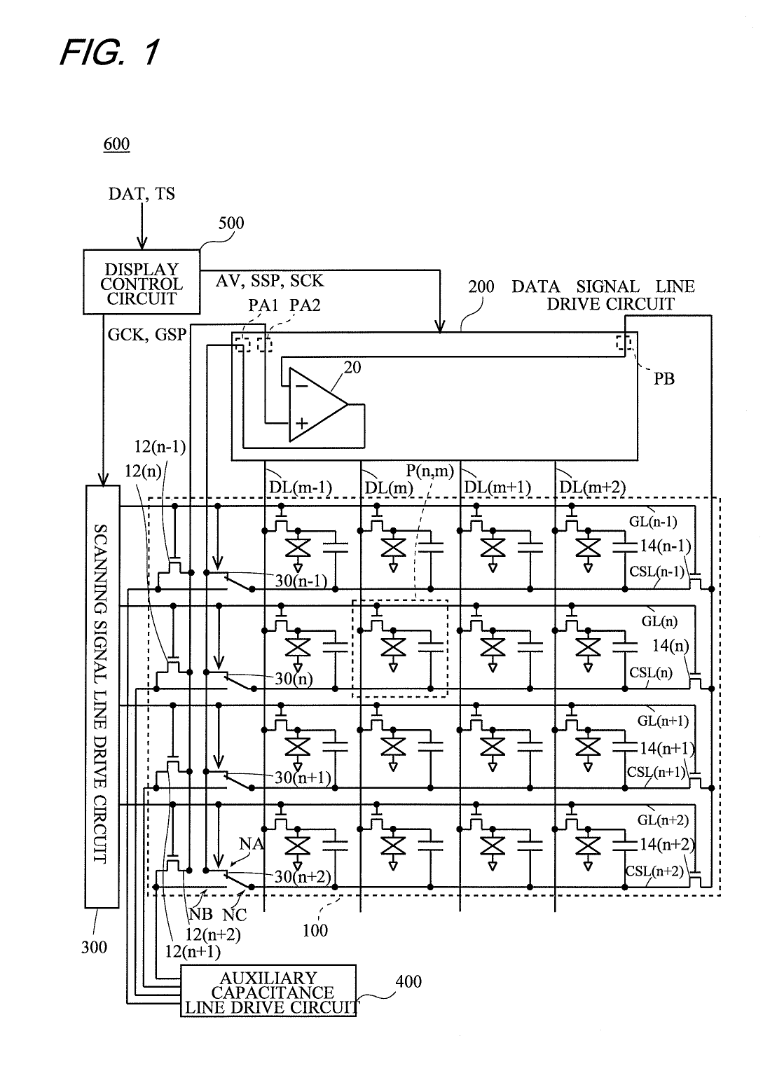

### MODES FOR CARRYING OUT THE INVENTION

### 0. Basic Examination

Prior to explanation of embodiments of the present invention, a basic examination made by the present inventors to solve the problem will be described.

<0.1 Configuration of Conventional Liquid Crystal Display Device>

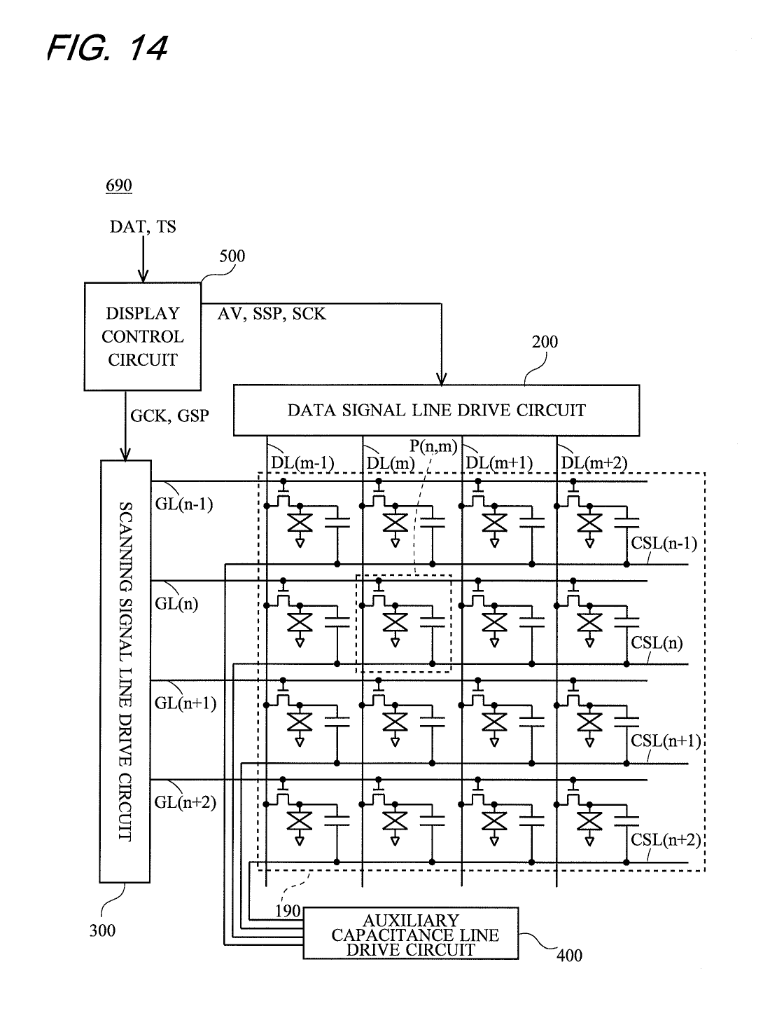

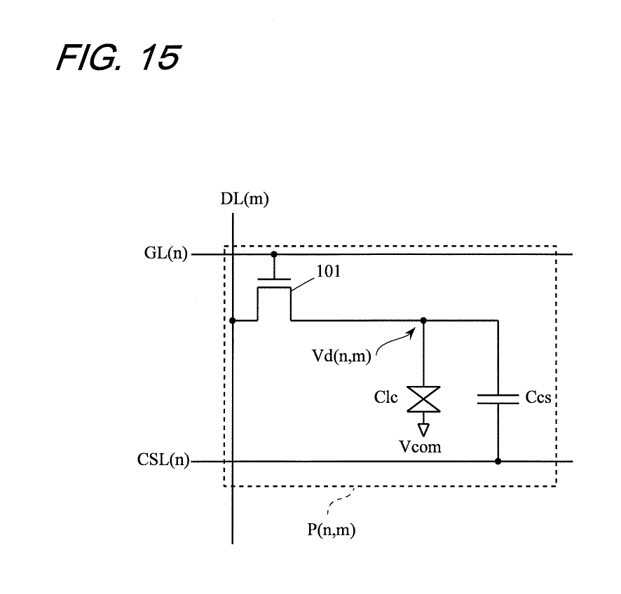

FIG. 14 is a circuit diagram illustrating an electrical configuration of a conventional liquid crystal display device in which polarity inversion drive is performed by changing a potential of a corresponding auxiliary capacitance line after completion of a selection period of each scanning signal line. As illustrated in FIG. 14, a conventional liquid crystal display device 690 has a display panel 190, a data signal line drive circuit 290, a scanning signal line drive circuit 300, an auxiliary capacitance line drive circuit 400, and a display control circuit 500.

The display panel 190 is made by a pair of electrode substrates sandwiching a liquid crystal layer, and a polarizing plate is adhered to the outer surface of each of the electrode substrates. One of the pair of electrode substrates is an active matrix-type substrate called a TFT (Thin Film Transistor) substrate. In the TFT substrate, a plurality of data signal lines DL(1) to DL(M) (hereinbelow, called data signal lines DL″ when they are not distinguished from one another) and a plurality of scanning signal lines GL(1) to GL(N) are formed in a lattice so as to cross each other on an insulating substrate such as a glass substrate and, further, a plurality of auxiliary capacitance lines CSL(1) to CSL(N) (hereinbelow, called “auxiliary capacitance lines CSL” when they are not distinguished from one another) which are respectively disposed along the plurality of scanning signal lines GL(1) to GL(N) (hereinbelow, called “scanning signal lines GL” when they are not distinguished from one another) and can be driven independently of one another are formed. A plurality of pixel circuits P(n, m) are formed in a matrix in correspondence with respective intersections of the plurality of data signal lines DL(1) to DL(M) and the plurality of scanning signal lines GL(1) to GL(N) (n=1 to N, and m=1 to M). Although only 16 pixel circuits are illustrated in FIG. 14 for convenience of the illustration, in reality, N×M pieces of pixel circuits are formed in the display panel 190. The other electrode substrate in the pair is called an opposed substrate in which an opposed electrode and an orientation film are sequentially stacked on an entire insulating substrate such as glass. The plurality of data signal lines DL(1) to DL(M), the plurality of scanning signal lines GL(1) to GL(N), and the plurality of auxiliary capacitance lines CSL(1) to CSL(N) are driven by the data signal line drive circuit 290, the scanning signal line drive circuit 300, and the auxiliary capacitance line drive circuit 400, respectively.

FIG. 14 is a circuit diagram illustrating an electrical configuration of the pixel circuit P(n, m). Each pixel circuit P(n, m) is provided in correspondence with any one of intersections of the plurality of data signal lines DL(1) to DL(M) and the plurality of scanning signal lines GL(1) to GL(N). Each pixel circuit P (n, m) includes a pixel TFT 101 whose source electrode is connected to the data signal line DL(m) passing a corresponding intersection and whose gate electrode is connected to the scanning signal line GL(n) passing the corresponding intersection and a pixel electrode connected to the drain electrode of the pixel TFT 101. A liquid crystal capacitance Clc is formed by the pixel electrode and the opposed electrode, and an auxiliary capacitance Ccs is formed by the pixel electrode and the auxiliary capacitance line CSL(n).

The display control circuit 500 receives display data DAT and a timing control signal TS from the outside and outputs, as signals for displaying an image represented by the display data DAT on the display panel 190, an analog image signal AV, a data start pulse signal SSP, a data clock signal SCK, a gate start pulse signal GSP, and a gate clock signal GCK.

The data signal line drive circuit 290 receives the analog image signal AV, the data start pulse signal SSP, and the data clock signal SCK which are output from the display control circuit 500 and sequentially applies the analog image signal AV to the data signal lines DL based on the data start pulse signal SSP and the data clock signal SCK. In such a manner, the data signal line drive circuit 290 performs driving by a so-called dot-sequential driving method. The present invention is not limited to the dot-sequential driving method. The data signal line drive circuit 290 may perform driving by a so-called SSD (Source Shared Driving) method as a method of grouping the plurality of data signal lines DL to groups each made of predetermined number of data signal lines DL and driving each of the groups by time-sharing predetermined number of data signals corresponding to each of the groups by an output buffer common to the predetermined number of data signal lines DL. In this case, the data signal line drive circuit 290 receives a digital image signal DV in place of the analog image signal AV, serial-parallel converts the digital image signal DV, and performs digital-to-analog conversion to thereby generate a data signal.

The scanning signal line drive circuit 300 sequentially selects the plurality of scanning signal lines GL(1) to GL(N) every horizontal scanning period in each of frame periods (vertical scanning periods) for displaying a display image on the display panel 190 and applies an active scanning signal (voltage to set the pixel TFT 101 included in the pixel circuit into a conductive state) to the selected scanning signal line.

The auxiliary capacitance line drive circuit 400 applies an auxiliary capacitance signal (predetermined low potential VL or predetermined high potential VH) as a bias of a voltage to be applied to a liquid crystal layer of the display panel 190 independently to the plurality of auxiliary capacitance lines CSL(1) to CSL(N). Note that, the potentials to be applied to the auxiliary capacitance lines are not limited to the two kinds of the low potential VL and the high potential VH. Potentials of three or more kinds may be used.

To the opposed electrode, a potential Vcom as a reference of the voltage to be applied to the liquid crystal layer of the display panel 190 is provided by a not-illustrated opposed electrode drive circuit.

As described above, a plurality of data signals are respectively applied to the plurality of data signal lines DL(1) to DL(M) and a plurality of scanning signals are respectively applied to the plurality of scanning signal lines GL(1) to GL(N), so that a voltage according to a pixel value of a pixel to be displayed using the opposed electrode potential Vcom as a reference is provided to the pixel electrode in each of the pixel circuits in the display panel 190 via the pixel TFT 101 and is held in the pixel capacitance made by the liquid crystal capacitance Clc and the auxiliary capacitance Ccs in the pixel circuit. Consequently, a voltage corresponding to the potential difference between each of the pixel electrodes and the opposed electrode is applied to the liquid crystal layer. By controlling the optical transmittance of the liquid crystal layer by the applied voltage, the display panel 190 displays an image represented by the display data DAT.

<0.2 Operation of Conventional Liquid Crystal Display Device>

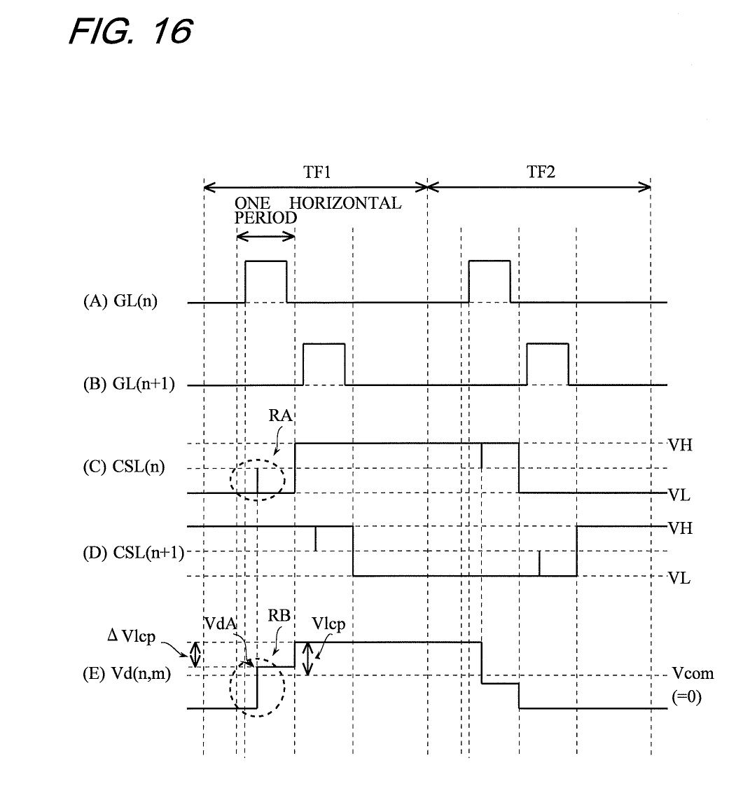

FIGS. 16(A) to 16(E) are diagrams illustrating the voltage waveform of the potential of the scanning signal line GL(n), the potential of the scanning signal line GL(n+1), the potential of the auxiliary capacitance line CSL(n), the potential of the auxiliary capacitance line CSL(n+1), and the potential Vd(n, m) of the pixel electrode (hereinbelow, called “pixel potential”), respectively, in a first frame period TF1 and a second frame period TF2 as successive two frame periods. Here, a description will be given of, byway of example, a case of employing a 1H inversion driving method of performing driving while inverting the polarity using the opposed electrode potential Vcom of a data signal to be applied to the data signal lines DL(1) to DL(m) as a reference every horizontal period and displaying an image in a normally black mode. Although Vcom is set to zero, the present invention is not limited to the value.

In the first frame period TF1, when the scanning signal line GL(n) enters a selection state (FIG. 16(A)), the pixel TFTs 101 in the pixel circuits P(n, 1) to P(n, M) connected to the scanning signal line GL(n) become conductive. In a period of writing the pixel circuit P(n, m), a positive potential VdA as a data signal is provided from the data signal line DL(m) to the pixel electrode, and pixel capacitance is charged. As a result, a pixel potential Vd(n, m) is held at VdA (FIG. 16(E)). Subsequently, when the scanning signal line GL(n) enters a non-selection state and the pixel TFTs 101 connected to the scanning signal line GL(n) are blocked, the charges accumulated in the pixel capacitance are held as they are. During the period, the potential of the auxiliary capacitance line CSL(n) is a predetermined low potential VL. After that, the potential of the auxiliary capacitance line CSL(n) changes to a predetermined high potential VH. After that, in a period until the next frame, the high potential VH is provided to the auxiliary capacitance line CSL(n), and a bias voltage AVlcP is added to the pixel potential Vd(n, m). As a result, the voltage VlcP illustrated in FIG. 16(E) is applied to a part sandwiched by the pixel electrode and the opposed electrode in the liquid crystal layer, and charges are held for a period until the pixel TFT 101 becomes conductive again. In the second frame period TF2 as the next frame, operation similar to that in the first frame period TF1 is performed (except that the polarity is inverted). By such operation, large voltage can be applied to the liquid crystal layer with small data signal amplitude, so that power consumption can be reduced.

<0.3 Consideration>

However, since the auxiliary capacitance Ccs is formed by the pixel electrode and the auxiliary capacitance line CSL(n) as described above, a potential fluctuation in the pixel potential Vd(n, m) which occurs at the time of writing the data signal to the pixel electrode is transmitted to the auxiliary capacitance line CSL(n) via the auxiliary capacitance Ccs. The amount ΔV of the potential fluctuation in the auxiliary capacitance line CSL(n) which occurs at this time (hereinbelow, also called “potential fluctuation ΔV”) is approximately expressed by the following equation (1).

ΔV=Vdpre(n,m)−Vdat (1)

where Vdpre(n, m) expresses a pixel potential decided by changing the potential of the auxiliary capacitance line CSL(n) after completion of the selection period of the scanning signal line GL(n) in a previous frame, and Vdat expresses voltage of a data signal to be written in the following frame.

As illustrated in FIG. 16(C), in the auxiliary capacitance line CSL(n), when the polarity of the pixel potential Vd n, m) changes from negative to positive and changes from positive to negative, the potential fluctuation ΔV occurs (indicated by a straight line in the figure). Similarly, as illustrated in FIG. 16(D), also in the auxiliary capacitance line CSL(n+1), when the polarity of the pixel potential Vd(n+1, m) changes (not illustrated), the potential fluctuation ΔV occurs (indicated by a straight line in the figure). For example, in reality, the auxiliary capacitance line CSL(n) is also influenced by the potential fluctuation in the pixel potentials Vd(n, 1) to Vd(n, m−1) and Vd(n, m+1) to Vd(n, M). However, its illustration and description are omitted for convenience. Also, when the pixel TFT 101 becomes conductive when the scanning signal line GL(n) enters a selection state, the pixel potential Vd(n, m) fluctuates also by the influence of parasitic capacitance in the data signal lines DL(1) to DL(M). However, its illustration and description are omitted for convenience.

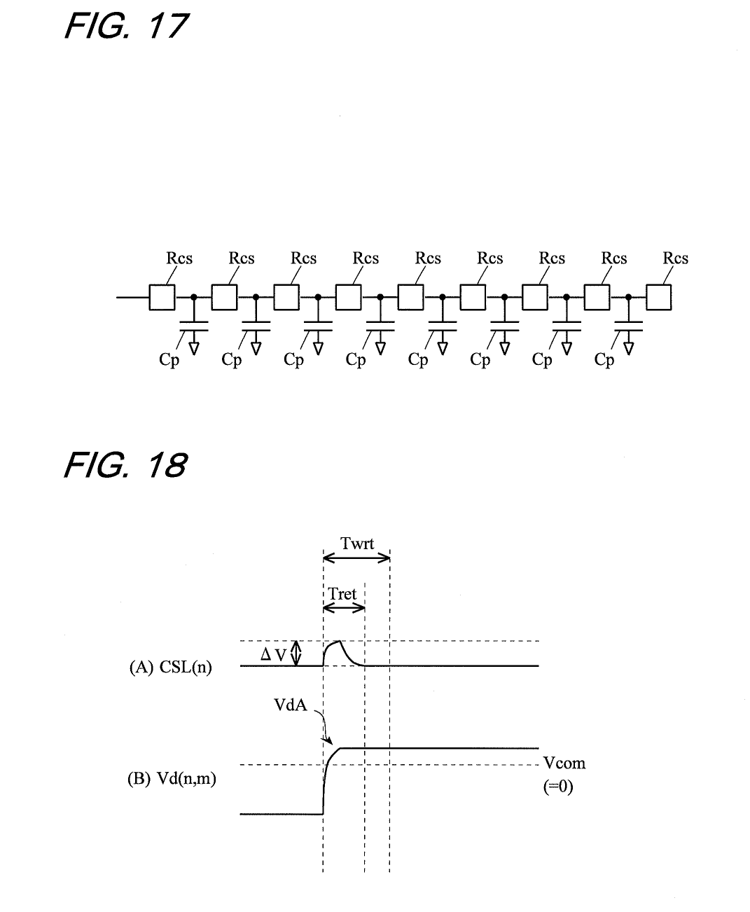

As illustrated in FIG. 17, the auxiliary capacitance line CSL(n) can be expressed by an equivalent circuit made by a wiring resistor Rcs and a parasitic capacitance Cp. The auxiliary capacitance line CSL(n) in which the potential fluctuation ΔV occurs tries to return to the initial potential by charging/discharging the charges held in the parasitic capacitance Cp. In the specification, time since a time point when the potential fluctuation ΔV occurs in the auxiliary capacitance line CSL(n) until a time point when the potential difference between the potential of the auxiliary capacitance line CSL(n) in which the potential fluctuation ΔV occurs and the initial potential becomes a predetermined small potential difference Δε (almost equal to 0 V) is called “recovery time Tret”. The recovery time Tret depends on the resistance value of the wiring resistor Rcs, the capacitance value of the parasitic capacitance Cp, and the potential fluctuation amount ΔV. That is, when the potential fluctuation amount ΔV is considered to be constant, the larger the time constant determined by the resistance value of the wiring resistor Rcs and the capacitance value of the parasitic capacitance Cp is, the longer the recovery time Tret becomes. As described above, to switch the potential of the auxiliary capacitance line CSL(n) between the low potential VL and the high potential VH, a selection switch is necessary for the auxiliary capacitance line drive circuit 400, so that the impedance of the auxiliary capacitance line CSL(n) seen from the auxiliary capacitance line drive circuit 400 further rises. Due to this, particularly, the time constant becomes larger and the recovery time Tret becomes longer by the method of performing polarity inversion driving by changing the potential of the corresponding auxiliary capacitance line after completion of the selection period of each scanning signal line.

FIGS. 18(A) and 18(B) are voltage waveform charts, in the case where Twrt>Tret, of the potential of the auxiliary capacitance line CSL(n) resulting from enlarging a part RA surrounded by the broken line in FIG. 16(C) and the pixel potential Vd(n, m) resulting from enlarging a part RB surrounded by the broken line in FIG. 16(E), respectively. Here, Twrt expresses the period of writing the pixel potential Vd(n, m). In the waveforms illustrated in FIGS. 18(A) and 18(B), the potential of the auxiliary capacitance line CSL(n) recovers within the write period Twrt of the pixel potential Vd(n, m). In this case, the pixel potential Vd(n, m) is not influenced by the potential fluctuation in the auxiliary capacitance line CSL(n).

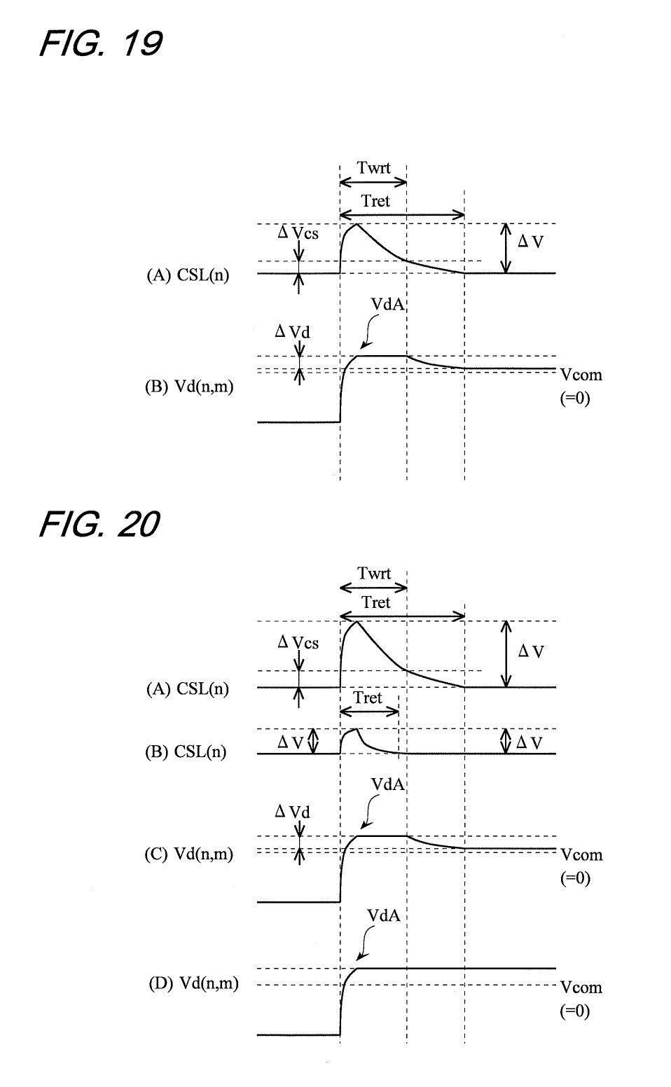

FIGS. 19(A) and 19(B) are voltage waveform charts, in the case where Twrt<Tret, of the potential of the auxiliary capacitance line CSL(n) resulting from enlarging the part RA surrounded by the broken line in FIG. 16(C) and the pixel potential Vd(n, m) resulting from enlarging the part RB surrounded by the broken line in FIG. 16(E), respectively. In the waveforms illustrated in the pixel potential diagrams 19(A) and 19(B), the potential of the auxiliary capacitance line CSL(n) does not recover within the write period Twrt of the pixel potential Vd(n, m). In this case, the pixel potential Vd(n, m) fluctuates only by a fluctuation amount ΔVd(ΔVd<ΔVcs) proportional to a residual voltage AVcs as the difference between the potential of the auxiliary capacitance line CSL(n) at the end time point of the write period Twrt and the potential of the original auxiliary capacitance line CSL(n). That is, the pixel potential Vd(n, m) becomes VdA−ΔVd which is the value different from the potential VdA to be held originally. It causes a lateral crosstalk.

When the resistance value of the wiring resistor Rcs and the capacitance value of the parasitic capacitance Cp are considered to be constant, whether the pixel potential Vd(n, m) is influenced or not is determined by the magnitude of the potential fluctuation amount ΔV in the auxiliary capacitance line CSL(n). FIGS. 20(A) and 20(C) are voltage waveform charts resulting from enlarging the parts RA and RB surrounded by the broken line in FIG. 16, respectively (in the case where the potential fluctuation amount ΔV is large). On the other hand, FIGS. 20(B) and 20(D) are voltage waveform charts resulting from enlarging the parts RA and RB surrounded by the broken line in FIG. 16, respectively (in the case where the voltage fluctuation amount ΔV is small). In the case where the potential fluctuation amount ΔV is small, Twrt>Tret is satisfied, so that the pixel potential Vd(n, m) is hardly influenced by the potential fluctuation amount ΔV (FIGS. 20(B) and 20(D)). On the other hand, in the case where the potential fluctuation amount ΔV is large, Twrt<Tret is satisfied and the residual voltage AVcs is generated, so that the pixel potential Vd(n, m) becomes a value different from the potential VdA to be held originally. It causes a lateral crosstalk as described above.

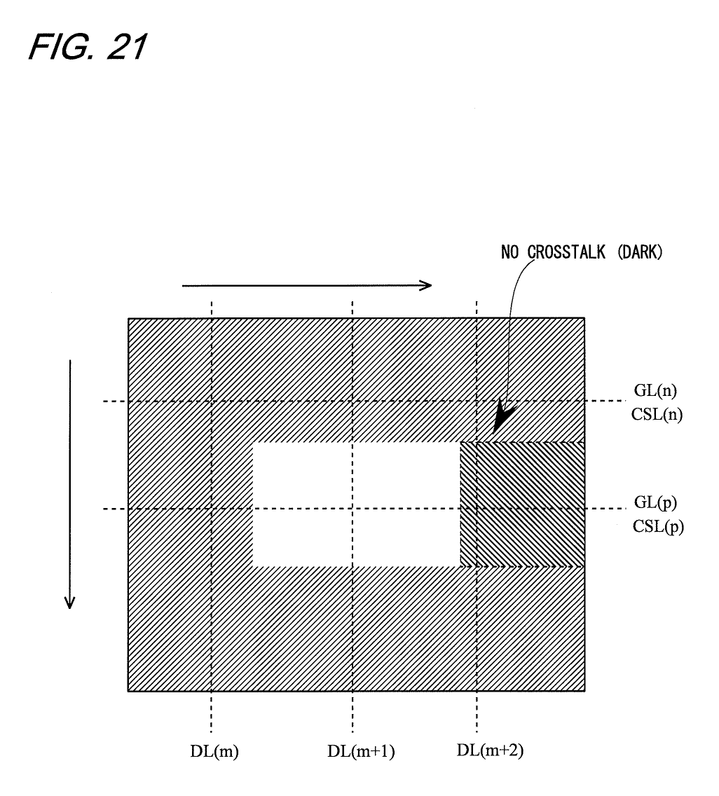

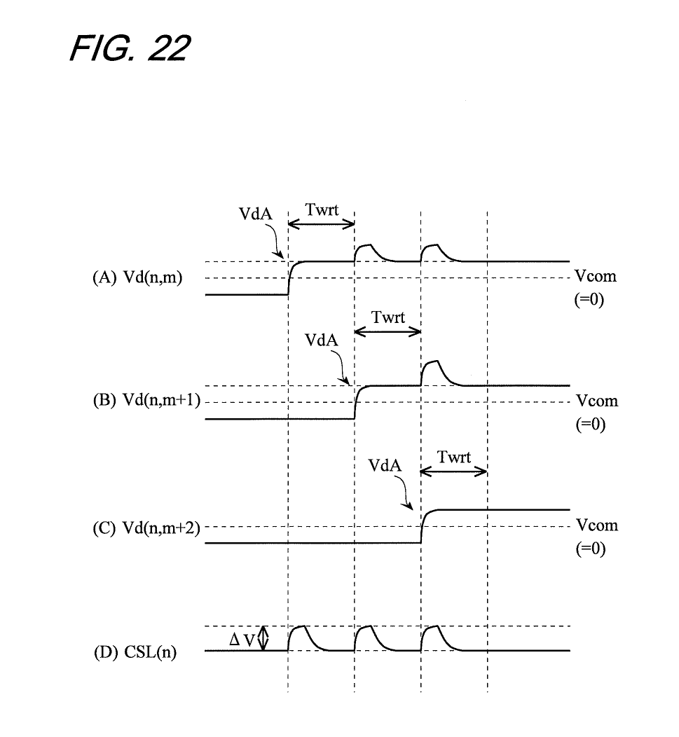

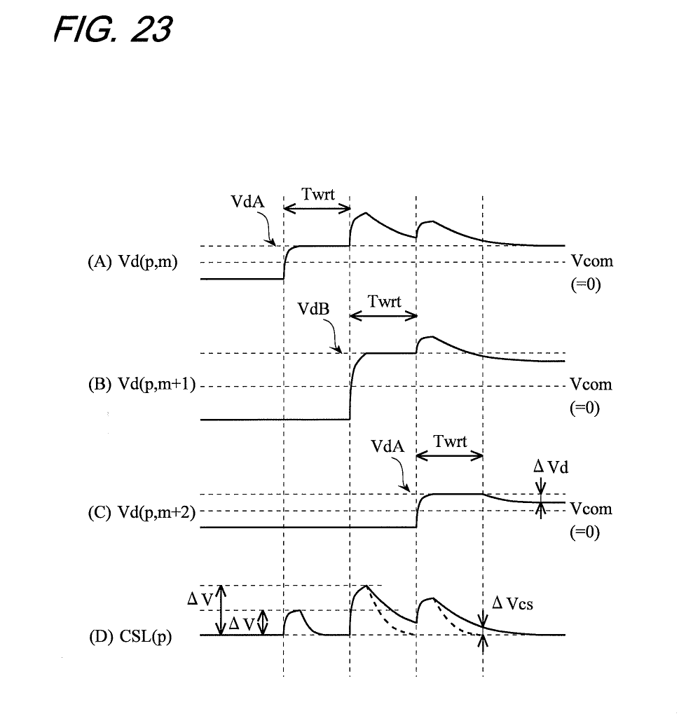

The above-described influence by the residual voltage AVcs on the pixel potential Vd(n, m) becomes conspicuous particularly in a display pattern made by a gray background part and a white center part as illustrated in FIG. 21. In FIG. 21, the gray background part is expressed by hatching of thin lines and a dark part which will be described later is expressed by hatching of thick lines. In FIG. 21, for convenience of explanation, the sizes of pixels are non-uniform. The downward arrow and the rightward arrow in FIG. 21 indicate a vertical scanning direction and a horizontal scanning direction, respectively, in image display. All of pixels corresponding to the scanning signal line GL(n) and the auxiliary capacitance line CSL(n) are gray and no display unevenness occurs. On the other hand, pixels corresponding to the scanning signal line GL(p) and the auxiliary capacitance line CSL(p) are gray or white. Pixels corresponding to the data signal line DL(m+2) are supposed to be gray but, due to occurrence of lateral crosstalk, are dark. The lateral crosstalk will now be described more specifically with reference to FIG. 21, FIGS. 22(A) to 22(D), and FIGS. 23(A) to 23(D).

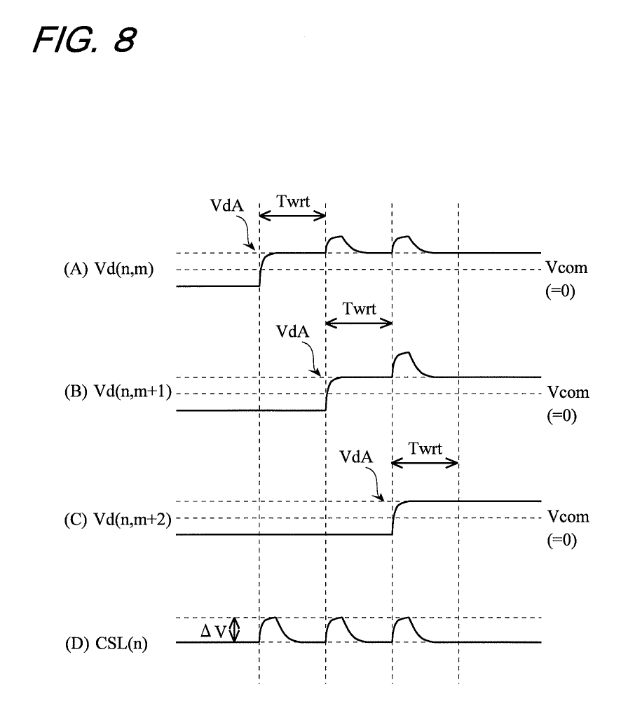

FIGS. 22(A) to 22(D) are voltage waveform charts of the pixel potentials Vd(n, m) to Vd(n, m+2) and the potential in the auxiliary capacitance line CSL(n) in FIG. 21, respectively. In the pixel potentials Vd(n, m) to Vd(n, m+2) illustrated in FIGS. 22(A) to 22(C), the influence of the potential fluctuation ΔV in the auxiliary capacitance line CSL(n) before the write period Twrt is omitted for convenience (also in FIGS. 8(A) to 8(C) which will be described later). In the potential in the auxiliary capacitance line CSL(n) illustrated in FIG. 22(D), the influence by the pixel potentials Vd(n, 1) to Vd(n, m−1) and Vd(n, m+3) to Vd(n, m) is omitted for convenience (also in FIG. 8(D) which will be described later). Since all of the pixels corresponding to the pixel potentials Vd(n, m) to Vd(n, m+2) are gray, the write potential of the pixel potentials Vd(n, m) to Vd(n, m+2) become the same VdA. Consequently, the amount ΔV of the potential fluctuation in the auxiliary capacitance line CSL(n) which occurs at the time of writing each of the pixel potentials is uniform. Therefore, no lateral crosstalk occurs in pixels corresponding to the scanning signal line GL(n) and the auxiliary capacitance line CSL(n).

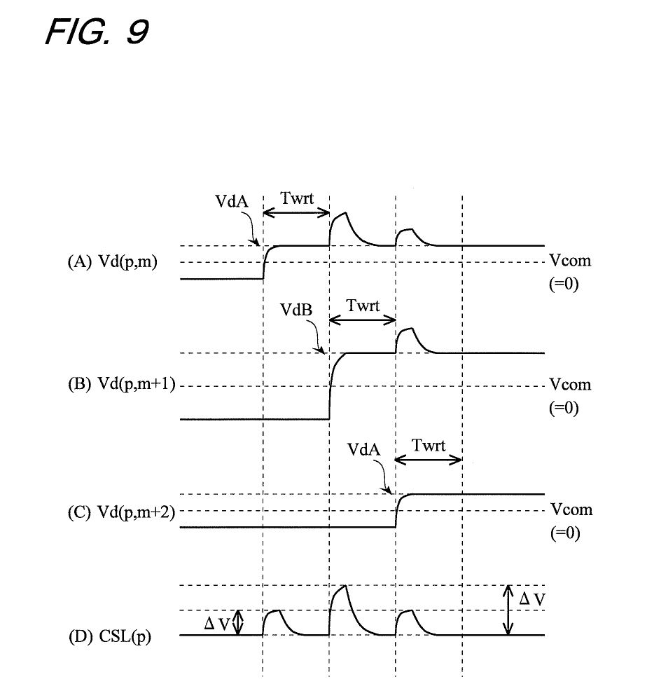

FIGS. 23(A) to 23(D) are voltage waveform charts of the pixel potentials Vd(p, m) to Vd(p, m+2) and the potential in the auxiliary capacitance line CSL(p) in FIG. 21, respectively. In the pixel potentials Vd(p, m) to Vd(p, m+2) illustrated in FIGS. 23(A) to 23(C), the influence of the potential fluctuation ΔV in the auxiliary capacitance line CSL(n) before the write period Twrt is omitted for convenience (also in FIGS. 9(A) to 9(C) which will be described later). In the potential in the auxiliary capacitance line CSL(p) illustrated in FIG. 23(D), the influence by the pixel potentials Vd(p, 1) to Vd(p, m−1) and Vd(p, m+3) to Vd(p, m) is omitted for convenience (also in FIG. 9(D) which will be described later). The pixels corresponding to the pixel potentials Vd(p, m) and Vd(p, m+2) are gray, and the pixels corresponding to the pixel potential Vd(p, m+1) are white. The write potential of Vd(p, m) and Vd(p, m+2) is VdA, and the write potential of the pixel potential Vd(p, m+1) is VdB (>VdA). Consequently, the amount ΔV of the potential fluctuation in the auxiliary capacitance line CSL(p) which occurs at the time of writing each of the pixel potentials Vd(p, m) and Vd(p, m+2) is small, and the amount ΔV of the potential fluctuation in the auxiliary capacitance line CSL(p) which occurs at the time of writing the pixel potential Vd(p, m+1) is large. In the case where the potential of the auxiliary capacitance potential CSL(p) which fluctuates largely at the time of writing the pixel potential Vd(p, m+1) does not recover to the original potential before completion of the writing of the pixel potential Vd(p, m+2), a deviation occurs in the potential of the auxiliary capacitance line CSL(p) at the start time of writing the pixel potential Vd(p, m+2) (in the figure, the solid lines indicate the potential in which the deviation occurs and the broken lines indicate ideal potentials). Due to the influence of the deviation in the potential of the auxiliary capacitance line CSL(p), the potential of the auxiliary capacitance CSL(p) does not recover to the original potential within the period of writing the pixel potential Vd(p, m+2), and the residual voltage AVcs is generated. As a result, the pixel potential Vd(p, m+2) becomes VdA−ΔVd which is the value different from the potential VdA to be held originally, and corresponding pixels become darker than gray which is to be displayed originally. The pixel potential Vd(p, m+1) corresponding to white display also becomes the value different from the potential VdB to be held originally and pixels become darker than the original color.

In the case of employing the configuration of the display device described in the Patent Document 4 to solve the above-described lateral crosstalk, as mentioned above, the auxiliary capacitance line drive circuits are necessary on both end sides of an auxiliary capacitance line, so that the circuit scale becomes larger. Due to this, it is difficult to narrow a frame and the power consumption increases. Further, since the potential is supplied from the both end sides of an auxiliary capacitance line, there is the possibility that, due to increase in the amplitude of the auxiliary capacitance potential, power consumption increases. It is therefore necessary to adjust timings of supplying the potential from the both end sides of the auxiliary capacitance line.

In the case of employing the configuration of the display device described in the Patent Document 5, as described above, a large auxiliary capacitance for voltage stabilization is necessary to sufficiently obtain an effect of suppressing a potential fluctuation in an auxiliary capacitance line. Consequently, a wide region for providing the auxiliary capacitance for voltage stabilization is necessary, and the aperture ratio decreases. Although the Patent Document 5 discloses an example of forming the auxiliary capacitance for voltage stabilization by using a common auxiliary capacitance line, it also needs a wider region, and the aperture ratio decreases.

In the case of employing the configuration of the liquid crystal display device described in the Patent Document 4 to solve the above-described lateral crosstalk, as mentioned above, a comparison circuit, a detection circuit, and an output circuit are necessary for each of the auxiliary capacitance lines, so that the circuit configuration becomes complicated.

The scanning signal line drive circuit 300 receives a gate start pulse GSP and a gate clock signal GCK from the display control circuit 500, sequentially selects a plurality of scanning signal lines GL(1) to GL(N) every horizontal scan period in each of frame periods (each of vertical scanning periods) for displaying a display image on the display panel 100, and applies an active scanning signal (voltage to set the pixel TFT 101 included in the pixel circuit into a conductive state) to the selected scanning signal line. In the embodiment, scan is performed in the ascending order of the numbers of the scanning signal lines GL. Specifically, the scanning signal lines are selected in the order of GL(1), GL(2), . . . , and GL(N). In the specification, such a scanning direction will be called the “first direction”.

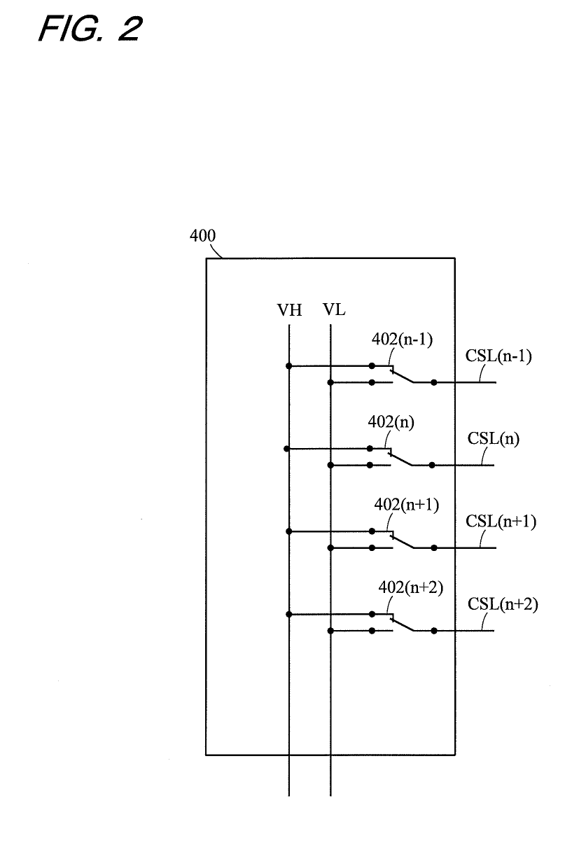

The auxiliary capacitance line drive circuit 400 applies an auxiliary capacitance signal (predetermined low potential VL or predetermined high potential VH) as a bias of a voltage to be applied to the liquid crystal layer in the display panel 100 to a plurality of auxiliary capacitance lines CSL(1) to CSL(N) independently. Specifically, as illustrated in FIG. 2, the auxiliary capacitance line drive circuit 400 includes potential switches 402(1) to 402(N) for switching potential to be applied to the auxiliary capacitance lines CSL(1) to CSL(N) between the low potential VL and the high potential VH.

<1.2 Configuration of Display Panel>

The display panel 100 is obtained by adding, to the display panel 190 of the conventional liquid crystal display device 690, output-end-side TFTs 12(1) to 12(N) (hereinbelow, called “output-end-side TFTs 12” when they are not distinguished from one another) as output-end-side switching elements provided on output-end-sides of the scanning signal lines GL(1) to GL(N), respectively. Auxiliary capacitance lines CSL adjacent to each other are connected to each other on their output-end-side via the output-end-side TFT 12. For example, auxiliary capacitance lines CSL(n−1) and CSL(n) are connected to each other on their output-end-side via an output-end-side TFT 12(n).

The gate electrode as a control terminal of each of the output-end-side TFTs 12 is connected to a corresponding scanning signal line GL, the source electrode as one of conduction terminals of each output-end-side TFT 12 is connected to the auxiliary capacitance line CSL disposed along the corresponding scanning signal line GL, and the drain electrode as the other conduction terminal of each output-end-side TFT 12 is connected to the auxiliary capacitance line CSL disposed along a scanning signal line preceding to the corresponding scanning signal line GL in the first direction. For example, the gate electrode of an output-end-side TFTs 12(n) is connected to a scanning signal line GL(n), the source electrode is connected to an auxiliary capacitance line CSL(n) disposed along the scanning signal line GL(n), and the drain electrode is connected to an auxiliary capacitance line CSL(n−1) disposed along a scanning signal line GL(n−1) preceding to the scanning signal line GL(n) in the first direction. Although the source electrode and the drain electrode of the corresponding output-end-side TFT 12 are switched depending on the potential of each auxiliary capacitance line CSL, in the following description, a terminal on the side connected an auxiliary capacitance line CSL disposed along a scanning signal line GL to which the gate electrode of the output-end-side TFT 12 is connected is a source electrode, and a terminal on the side connected to the auxiliary capacitance line CSL disposed along a scanning signal line GL preceding to the scanning signal line GL in the scanning direction is a drain electrode.

Each of the output-end-side TFTs 12 is controlled to enter the conduction state when the scanning signal line GL connected to the gate electrode is in a selection state and to enter the blocking state when the scanning signal line GL is in a non-selection state. For example, an output-end-side TFT 12(n) is controlled to enter the conduction state when a scanning signal line GL(n) connected to the gate electrode is in a selection state and to enter the blocking state when the scanning signal line GL(n) is in a non-selection state.

<1.3 Operation>

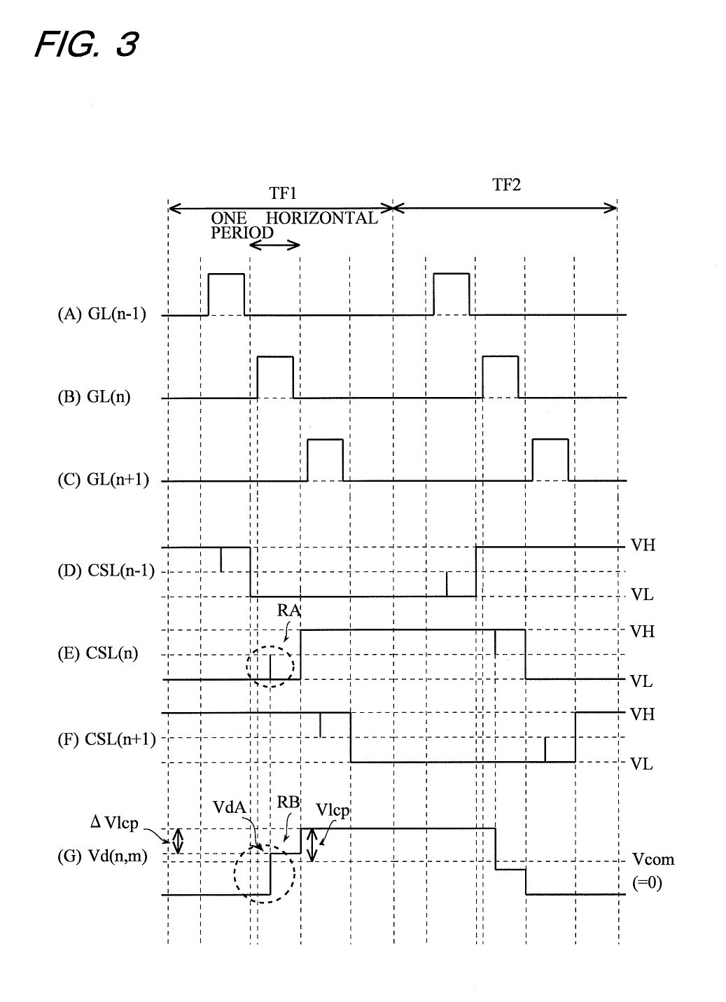

With reference to FIGS. 3(A) to 3(G), FIGS. 4(A) to 4(C), FIG. 5, and FIG. 6, the operation of the liquid crystal display device 600 of the embodiment will be described.

FIGS. 3(A) to 3(G) are voltage waveform charts of a potential in a scanning signal line GL(n−1), a potential in a scanning signal line GL(n), a potential in a scanning signal line GL(n+1), a potential in an auxiliary capacitance line

CSL(n−1), a potential in an auxiliary capacitance line CSL(n), a potential in an auxiliary capacitance line CSL(n+1), and a pixel potential Vd(n, m), respectively, in a first frame period TF1 and a second frame period TF2 as successive two frame periods. In the embodiment, like in the conventional liquid crystal display device, a description will be given of, by way of example, a case of employing a 1H inversion driving method of performing driving while inverting the polarity using an opposed electrode potential Vcom of a data signal to be applied to the data signal lines DL(1) to DL(m) as a reference every horizontal period and displaying an image in a normally black mode. Although Vcom is set to zero, the present invention is not limited to the value.

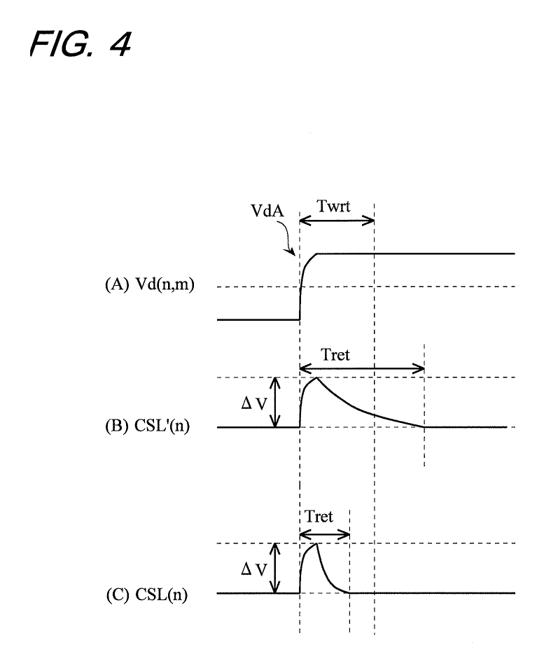

FIGS. 4(A) to 4(C) are voltage waveform charts of a pixel potential Vd(n, m) resulting from enlarging a part RB surrounded by a broken line in FIG. 3(G), a potential in an auxiliary capacitance line CSL′(n) in the conventional liquid crystal display device resulting from enlarging a part RA surrounded by a broken line in FIG. 3(E), and a potential of an auxiliary capacitance line CSL(n) in the embodiment resulting from enlarging the part RA surrounded by the broken line in FIG. 3(E).

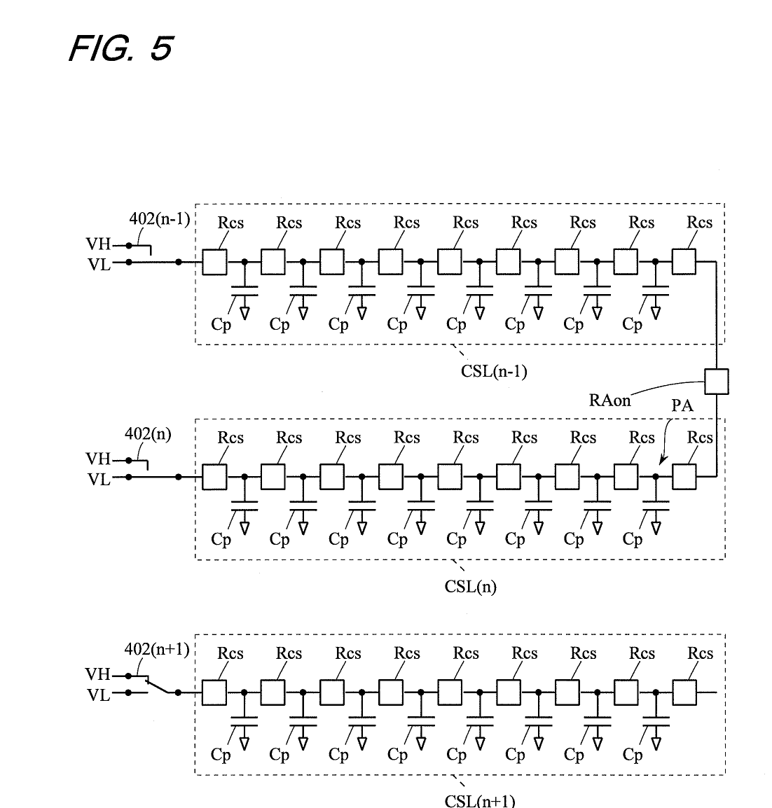

In the first frame period TF1, when the scanning signal line GL(n) is in a selection state (FIG. 3(B)), the pixel TFTs 101 in pixel circuits P(n, 1) to P(n, M) connected to the scanning signal line GL(n) enter a conduction state. At this time, the output-end-side TFT 12(n) enters the conduction state. When the output-end-side TFT 12(n) enters the conduction state, an auxiliary capacitance line CSL(n) disposed along the scanning signal line GL(n) which is in the selection state and an auxiliary capacitance line CSL(n−1) disposed along a scanning signal line GL(n−1) preceding to the scanning signal line GL(n) in the first direction are connected to each other. The auxiliary capacitance lines CSL(n−1) to CSL(n+1) at this time are expressed by equivalent circuits made by wiring resistors Rcs and parasitic capacitances Cp illustrated in FIG. 5. At this time, both of the potential applied to the auxiliary capacitance line CSL(n−1) and the potential provided to the auxiliary capacitance line CSL(n) are the low potential VL, and the potential provided to the auxiliary capacitance line CSL(n+1) is the high potential VH. The auxiliary capacitance lines CSL(n−1) and CSL(n) are connected to each other via the output-end-side TFT 12(n) (an on resistor RAon) which enters a conduction state.

In a write period for the pixel circuit P(n, m), a positive potential VdA as a data signal is supplied from the data signal line DL(m) to a pixel electrode to charge the pixel capacitance. Since a potential fluctuation in the pixel potential Vd(n, m) which occurs at the time of writing a data signal to a pixel electrode is transmitted to the auxiliary capacitance line CSL(n) via the parasitic capacitance Cdc as described in the basic consideration, a potential fluctuation ΔV occurs in the auxiliary capacitance line CSL(n) (the part RA surrounded by a broken line in FIG. 3(E)). As illustrated in FIGS. 3(D) to 3(F), in the auxiliary capacitance lines CSL(n−1) to CSL(n+1), the potential fluctuation ΔV occurs when the polarity of the pixel potential Vd(n, m) changes (indicated by a straight line in the figures). For example, in reality, the auxiliary capacitance line CSL(n) is influenced also by potential fluctuations in the pixel potentials Vd(n, 1) to Vd(n, m−1) and Vd(n, m+1) to Vd(n, M). However, its illustration and description are omitted for convenience. When the scanning signal line GL(n) is in a selection state and the pixel TFT 101 enters the conduction state, fluctuations occur in the pixel potential Vd(n, m) also by the influence of parasitic capacitances in the data signal lines DL(1) to DL(M). However, its illustration and description are omitted for convenience.

Attention is now paid to a part close to the output end indicated as PA in FIG. 5 (hereinbelow, simply called “PA”). When the potential fluctuation ΔV occurs in PA, charging/discharging occurs between the parasitic capacitances Cp around PA. In the conventional liquid crystal display device, a final charging/discharging destination for converging the potential fluctuation ΔV occurring in PA is only in the direction where the potential switch 402(n) is connected. In the embodiment, however, the auxiliary capacitance lines CSL(n) and CSL(n−1) are connected to each other via the output-end-side TFT 12(n). Consequently, there are two final charging/discharging destinations for converging the potential fluctuation ΔV occurring in PA in the direction where the potential switch 402(n) is connected and the direction where the potential switch 402(n−1) is connected. That is, the impedance seen from PA is seemingly reduced to almost the half of that in the conventional device (the time constant becomes almost half). With distance from PA toward the direction where the potential switch 402(n) is connected, the reduction ratio of the apparent impedance becomes lower. The “reduction ratio of impedance” denotes the ratio of reduction in the impedance in the embodiment in comparison with the impedance in the conventional liquid crystal display device.

In the case where the potential fluctuation ΔV occurs at the time of writing a data signal, the potential of the auxiliary capacitance line CSL′(n) does not recover within the data signal write period Twrt in the conventional liquid crystal display device (FIG. 4(B)). In contrast, in the embodiment, the time constant becomes almost the half, so that the recovery time Tret becomes almost the half. Consequently, even in the case where the potential fluctuation ΔV of the same magnitude occurs, the potential of the auxiliary capacitance line CSL(n) recovers within the write period Twrt (FIG. 4(C)). Therefore, a residual voltage AVcs as the difference between the potential in the auxiliary capacitance line CSL(n) at the time point of completion of the write period Twrt and the original potential in the auxiliary capacitance line CSL(n) is not generated, so that the potential VdA to be originally held is held at the pixel potential Vd(n, m) (FIGS. 3(G) and 4(A)).

Next, when the scanning signal line GL(n) is in a non-selection state and the pixel TFT 101 connected to the scanning signal line GL(n) enters the blocking state, the charges accumulated in the pixel capacitance are held as they are. During the period, the potential of the auxiliary capacitance line CSL(n) is the low potential VL. After that, the potential of the auxiliary capacitance line CSL(n) changes to the high potential VH. Subsequently, in the period until the next frame, the high potential VH is provided to the auxiliary capacitance line CSL(n), and a bias voltage AVlcP is added to the pixel potential Vd(n, m). As a result, a voltage VlcP illustrated in FIG. 3(G) is applied to a part sandwiched between the pixel electrode and the opposed electrode in the liquid crystal layer, and for a period until the pixel TFT 101 becomes conductive again, charges are held. By such operation, a large voltage can be applied to the liquid crystal layer with small data signal amplitude, so that the power consumption can be reduced.

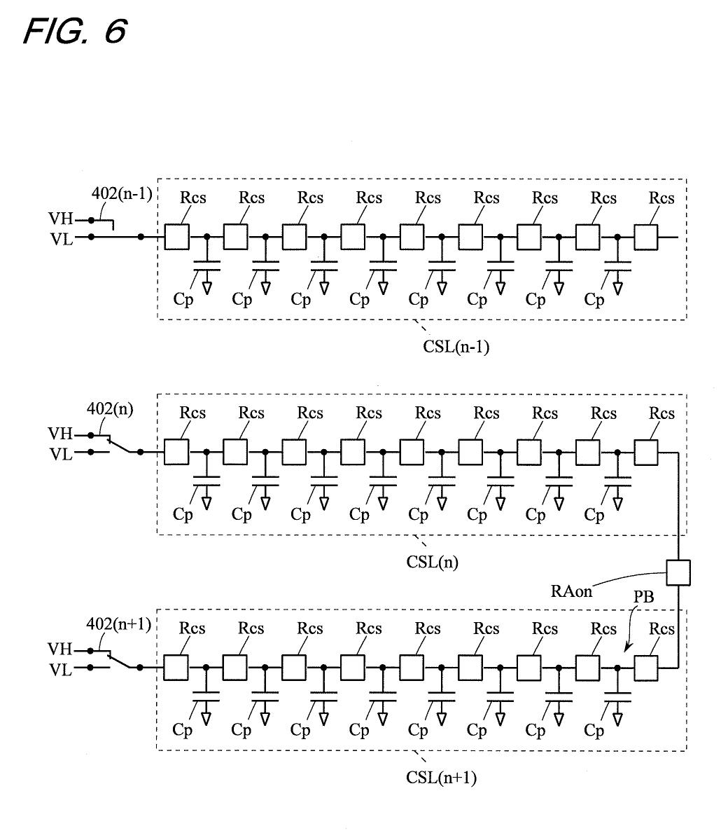

Similarly, when the scanning signal line GL(n+1) is in a selection state (FIG. 3(C)), the pixel TFTs 101 in the pixel circuits P(n+1, 1) to P(n+1, M) connected to the scanning signal line GL(n+1) enter the conduction state. At this time, the output-end-side TFT 12(n+1) enters the conduction state. When the output-end-side TFT 12(n+1) enters the conduction state, the auxiliary capacitance line CSL(n+1) disposed along the scanning signal line GL(n+1) which is in the selection state and the auxiliary capacitance line CSL(n) disposed along the scanning signal line GL(n) preceding to the scanning signal line GL(n+1) in the first direction are connected to each other. The auxiliary capacitance lines CSL(n−1) to CSL(n+1) at this time are expressed by equivalent circuits each made by the wiring resistors Rcs and the parasitic capacitances Cp illustrated in FIG. 6. At this time, the potential provided to the auxiliary capacitance line CSL(n−1) is the low potential VL and the potential provided to the auxiliary capacitance line CSL(n) and CSL(n+1) is the high potential VH. The auxiliary capacitance lines CSL(n) and CSL(n+1) are connected to each other via the output-end-side TFT 12(n+1) (an on resistor Ron) which enters a conduction state. Also in a part close to the output end and indicated by PB in FIG. 6, like in the above described PA, the impedance seen from PB seemingly becomes almost the half of that in the conventional device. The following operation is similar to that in the above description and its description will not be repeated.

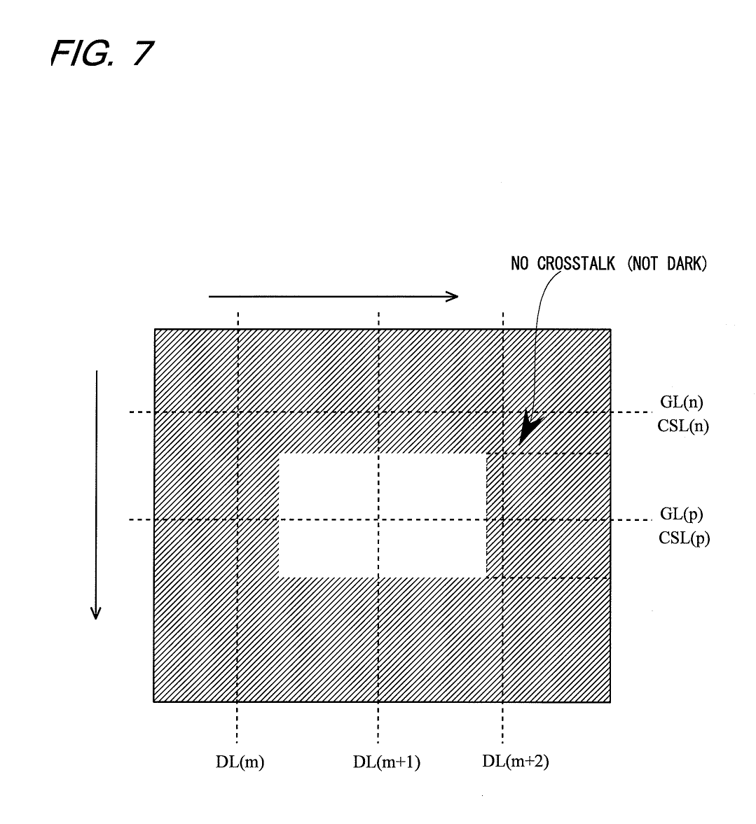

With reference to FIGS. 7 to 9, a state that a lateral crosstalk is suppressed in the embodiment will be described. FIG. 7 is a diagram illustrating a state of displaying a display pattern similar to the display pattern made by the gray background part and the white center part illustrated in FIG. 21 in the embodiment. In FIG. 7, the gray background part is expressed by hatching. In FIG. 7, for convenience of explanation, the sizes of pixels are non-uniform. Further, the downward arrow and the upward arrow in FIG. 7 indicate a vertical scanning direction and a horizontal scanning direction, respectively, in image display.

FIGS. 8(A) to 8(D) are voltage waveform charts of the pixel potentials Vd(n, m) to Vd(n, m+2) and the potential in the auxiliary capacitance line CSL(n) in FIG. 7, respectively. Since all of the pixels corresponding to the pixel potentials Vd(n, m) to Vd(n, m+2) are gray, the write potentials of the pixel potentials Vd(n, m) to Vd(n, m+2) become the same VdA. Consequently, the amount of the potential fluctuation in the auxiliary capacitance line CSL(n) which occurs at the time of writing each of the pixel potentials is uniform. Therefore, no lateral crosstalk occurs in pixels corresponding to the scanning signal line GL(n) and the auxiliary capacitance line CSL(n). As described above, in the case where pixels of the same color (gray) are successive, display is similar to that in the conventional liquid crystal display device.

FIGS. 9(A) to 9(D) are voltage waveform charts of the pixel potentials Vd(p, m) to Vd(p, m+2) and the potential in the auxiliary capacitance line CSL(p) in FIG. 7, respectively. The pixels corresponding to the pixel potentials Vd(p, m) and Vd(p, m+2) are gray, and the pixels corresponding to the pixel potential Vd(p, m+1) are white. The write potential of Vd(p, m) and Vd(p, m+2) is VdA, and the write potential of the pixel potential Vd(p, m+1) is VdB (>VdA). Consequently, the amount ΔV of the potential fluctuation in the auxiliary capacitance line CSL(p) which occurs at the time of writing each of the pixel potentials Vd(p, m) and Vd(p, m+2) is small, and the amount ΔV of the potential fluctuation in the auxiliary capacitance line CSL(p) which occurs at the time of writing the pixel potential Vd(p, m+1) is large. However, in the embodiment, apparent impedance in the auxiliary capacitance line CSL is reduced as described above. Consequently, different from the conventional liquid crystal display device 690 described in the basic examination, even when the potential of the auxiliary capacitance CSL(p) fluctuates largely at the time of writing the potential Vd(p, m+1), the fluctuated potential recovers to the original potential before writing of the pixel potential Vd(p, m+2), and no deviation occurs in the potential of the auxiliary capacitance line CSL(p) at the start time of writing the pixel potential Vd(p, m+2). Therefore, since the potential fluctuation in the auxiliary capacitance line CSL(p) which occurs at the time of writing the pixel potential Vd(p, m+2) is also solved in the write period, the residual voltage AVcs is not generated. As a result, the pixel potential Vd(p, m+2) is held at the original write potential VdA, so that pixels corresponding to the pixel potential Vd(p, m+2) become gray similar to the color to be originally displayed and does not become darker. As described above, in the display pattern displayed by the liquid crystal display device 600 according to the embodiment, different from the display pattern displayed by the conventional liquid crystal display device, no lateral crosstalk occurs.

<1.4 Effects>

In the embodiment, in the case where the scanning direction of the scanning signal lines GL is the ascending order of the numbers of the scanning signal lines GL, when a scanning signal line GL(n) is selected, an auxiliary capacitance line CSL(n) disposed along the scanning signal line GL(n) and an auxiliary capacitance line CSL(n−1) disposed along a scanning signal line GL(n−1) which is preceding to the scanning signal line GL(n) in a scanning direction are connected to each other, so that apparent impedance in the auxiliary capacitance line CSL(n) is reduced as compared with that in the conventional technique. Therefore, the time Tret until the potential of the auxiliary capacitance line CSL(n) fluctuated at the time of writing a data signal recovers to the original potential becomes shorter than that in the conventional technique. Thus, no fluctuation occurs in the pixel potential Vd(n, m) due to the potential fluctuation in the auxiliary capacitance line CSL(n). To realize the embodiment, it is sufficient to add an output-end-side TFT 12 on the output end side of each scanning signal line GL. Further, it is unnecessary to separately use a signal for controlling the output-end-side TFT 12. Therefore, a lateral crosstalk can be suppressed with the simple configuration.

To sufficiently suppress a potential fluctuation in the auxiliary capacitance line CSL(1), a dummy auxiliary capacitance line CSL(0) may be provided at an anterior stage of the auxiliary capacitance line CSL(1). In this case, to the auxiliary capacitance line CSL(0), the drain electrode of the output-end-side TFT 12(1) is connected.

### 2. Second Embodiment

### 2.1 Configuration of Liquid Crystal Display Device

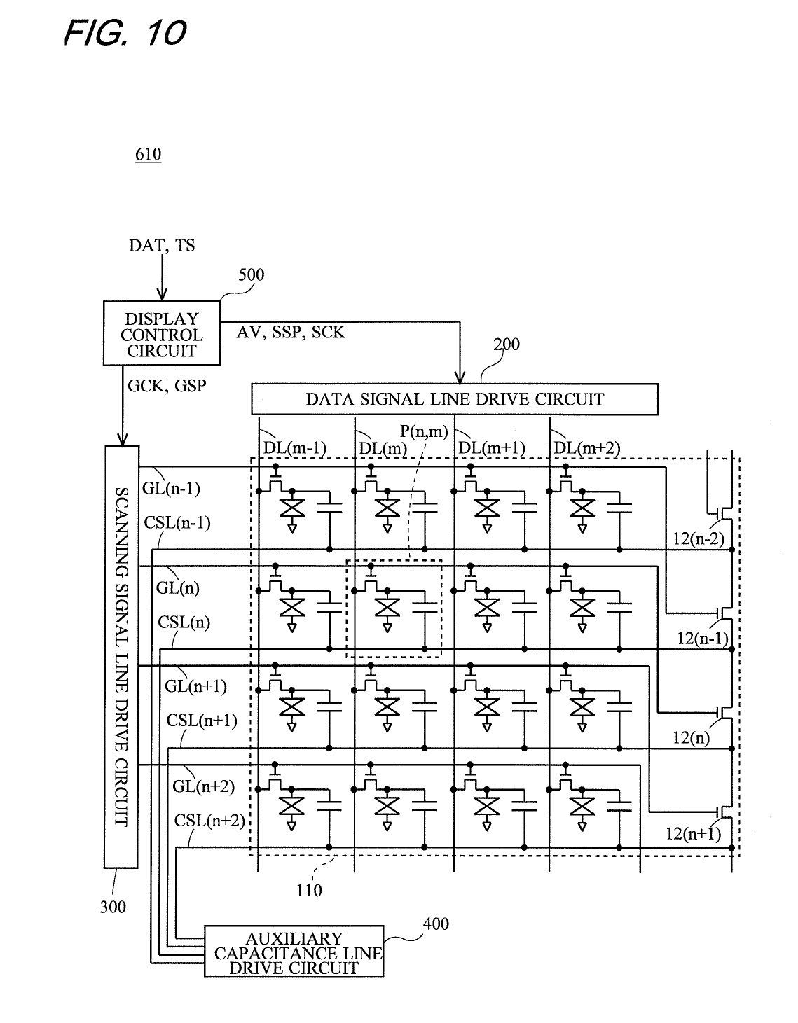

FIG. 10 is a circuit diagram illustrating an electrical configuration of a liquid crystal display device 610 according to a second embodiment of the present invention. The liquid crystal display device 610 of the embodiment has a configuration similar to that of the liquid crystal display device 600 of the first embodiment except for having a display panel 110 in place of the display panel 100 and except for the scanning direction of the scanning signal line GL. The same reference numerals are designated to the same components as those of the first embodiment in the components of the embodiment and their description will not be repeated.

Although a scan is made in the ascending order of the numbers of the scanning signal lines GL in the first embodiment, in the embodiment, a scan is made in the descending order of the numbers of the scanning signal lines GL. Specifically, the scanning signal lines GL are selected in order of GL(N), GL(N−1), . . . , and GL(1). In the specification, the scanning direction opposite to the first direction will be called a “second direction”.

### 2.2 Configuration of Display Panel

The method of connecting the output-end-side TFTs 12 in the display panel 110 in the embodiment is different from that of the display panel 100 in the first embodiment. Specifically, the gate electrode as a control terminal of each of the output-end-side TFTs 12 is connected to a corresponding scanning signal line GL, the source electrode as one of conduction terminals of each of the output-end-side TFTs 12 is connected to the auxiliary capacitance line CSL disposed along the corresponding scanning signal line GL, and the drain electrode as the other conduction terminal of each of the output-end-side TFTs 12 is connected to an auxiliary capacitance line CSL disposed along a scanning signal line preceding to the corresponding scanning signal line GL in the second direction. For example, the gate electrode of an output-end-side TFTs 12(n) is connected to a scanning signal line GL(n), the source electrode is connected to an auxiliary capacitance line CSL(n) disposed along the scanning signal line GL(n), and the drain electrode is connected to a scanning signal line GL(n+1) preceding to the scanning signal line GL(n) in the second direction. Since the direction of current flowing in the output-end-side TFT 12(n) in the embodiment is different from that in the first embodiment, the source electrode and the drain electrode in the embodiment and those in the first embodiment are opposite.

In a manner similar to the first embodiment, each of the output-end-side TFTs 12 is controlled to enter the conduction state when the scanning signal line GL connected to the gate electrode is in a selection state and to enter the blocking state when the scanning signal line GL is in a non-selection state. For example, an output-end-side TFT 12(n) is controlled to enter the conduction state when a scanning signal line GL(n) connected to the gate electrode is in a selection state and to enter the blocking state when the scanning signal line GL(n) is in a non-selection state.

Since the operation of the liquid crystal display device 610 in the embodiment is similar to that of the first embodiment except that the scanning direction is the second direction, its description will not be repeated.

### 2.3 Effects

According to the embodiment, in the case where the scanning direction of the scanning signal lines GL is the descending order of the numbers of the scanning signal lines GL, effects similar to those of the first embodiment can be produced.

To sufficiently suppress a potential fluctuation in the auxiliary capacitance line CSL(N), a dummy auxiliary capacitance line CSL(N+1) may be provided at a posterior stage of the auxiliary capacitance line CSL(N). In this case, to the auxiliary capacitance line CSL(N+1), the drain electrode of the output-end-side TFT N is connected.

### 3. Third Embodiment

### 3.1 Configuration of Liquid Crystal Display Device

FIG. 11 is a circuit diagram illustrating an electrical configuration of a liquid crystal display device 620 according to a third embodiment of the present invention. The liquid crystal display device 620 of the embodiment has a configuration similar to that of the liquid crystal display device 600 of the first embodiment except that a scanning signal line drive circuit 310 which can perform a bidirectional scan is provided in place of the scanning signal line drive circuit 300, an auxiliary capacitance line drive circuit 410 is provided in place of the auxiliary capacitance line drive circuit 400, and a display panel 120 is provided in place of the display panel 100. The same reference numerals are designated to the same components as those of the first embodiment in the components of the embodiment and their description will not be repeated.

The scanning signal line drive circuit 310 in the embodiment is configured so that the scanning direction of the scanning signal line GL can be switched between the first and second directions. The switching is performed based on a scanning-direction control signal UD supplied from the outside. For example, in the case where a predetermined high potential UDH is given as the scanning-direction control signal UD, the scanning direction becomes the first direction. In the case where a predetermined low potential UDL is given as the scanning-direction control signal UD, the scanning direction becomes the second direction. FIG. 11 illustrates an example of the case where the high potential UDH is given as the scanning-direction control signal UD (the scanning direction is the first direction).

The auxiliary capacitance line drive circuit 410 in the embodiment is configured so as to be able to switch the order of changing the potential of an auxiliary capacitance signal to be given to the auxiliary capacitance lines CSL(1) to CSL(N) according to the scanning direction (the first or second direction) of the scanning signal line GL. In a manner similar to the switching of the scanning direction in the scanning signal line drive circuit 310, the switching is performed based on the scanning-direction control signal UD supplied from the outside.

### 3.2 Configuration of Display Panel

The display panel 120 in the embodiment further includes, in addition to the components included in the display panel 100 in the first embodiment, scanning signal line change-over switches 22(1) to 22(N) (hereinbelow, called “scanning signal line change-over switches 22” when they are not distinguished from one another) provided in correspondence with the scanning signal lines GL(1) to GL(N), respectively. The switching terminal NA as one of switching terminals of each of the scanning signal line change-over switches 22 is connected to a corresponding scanning signal line GL, the switching terminal NB as the other switching terminal is connected to a scanning signal line GL preceding to the corresponding scanning signal line GL in the first direction, and the common terminal NC is connected to the gate electrode as a control terminal of each of the output-end-side TFTs 12. For example, the switching terminal NA of the scanning signal line change-over switch 22(n) is connected to the corresponding scanning signal line GL(n), the switching terminal NB is connected to the scanning signal line GL(n−1) preceding to the scanning signal line GL(n) in the first direction, and the common terminal NC is connected to the gate electrode of the output-end-side TFT 12(n). The scanning signal line change-over switches 22 are controlled by the scanning direction control signal UD.

In the case where the high potential UDH is given as the scanning direction control signal UD, each of the scanning signal line change-over switches 22 is controlled to select the switching terminal NA. In this case, when the scanning signal line change-over switch 22(n) selects the switching terminal NA, the gate electrode of the output-end-side TFT 12(n) is connected to the corresponding scanning signal line GL(n), the side connected to the auxiliary capacitance line CSL(n) of the input/output terminals of the output-end-side TFT 12(n) serves as the source electrode, and the side connected to the auxiliary capacitance line CSL(n−1) serves as the drain electrode. Thus, in the case where the high potential UDH is given as the scanning direction control signal UD, connection of the output-end-side TFTs 12 becomes similar to that in the first embodiment.

On the other hand, in the case where the low potential UDH is given as the scanning direction control signal UD, each of the scanning signal line change-over switches 22 is controlled to select the switching terminal NB. In this case, when each of the scanning signal line change-over switches 22 selects the switching terminal NB, the gate electrode of the output-end-side TFT 12(n) is connected to the corresponding scanning signal line GL(n−1), the side connected to the auxiliary capacitance line CSL(n) of the input/output terminals of the output-end-side TFT 12(n) serves as the drain electrode, and the side connected to the auxiliary capacitance line CSL(n−1) serves as the source electrode. The output-end-side TFT 12(n−1) corresponding to the scanning signal line GL(n) corresponds to the output-end-side TFT 12(n) in the second embodiment. Thus, in the case where the low potential UDL is given as the scanning direction control signal UD, connection of the output-end-side TFTs 12 becomes similar to that in the second embodiment.

### 3.3 Operation

The operation of the liquid crystal display device 620 in the embodiment is similar to that of the liquid crystal display device 600 in the first embodiment in the case where the high potential UDH is given as the scanning direction control signal UD, and is similar to that of the liquid crystal display device 610 in the second embodiment in the case where the low potential UDL is given as the scanning direction control signal UD.

### 3.4 Effects

According to the embodiment, in the case where the scanning direction of the scanning signal line GL is switchable, effects similar to those of the first embodiment can be produced.

To sufficiently suppress a potential fluctuation in the auxiliary capacitance line CSL(1) in the case where the high potential UDH is given as the scanning direction control signal UD (the scanning direction is the first direction), a dummy auxiliary capacitance line CSL(0) may be provided at an anterior stage of the auxiliary capacitance line CSL(1). In this case, to the auxiliary capacitance line CSL(0), the drain electrode of the output-end-side TFT 12(1) is connected.

### 4. Fourth Embodiment

### 4.1 Configuration of Liquid Crystal Display Device

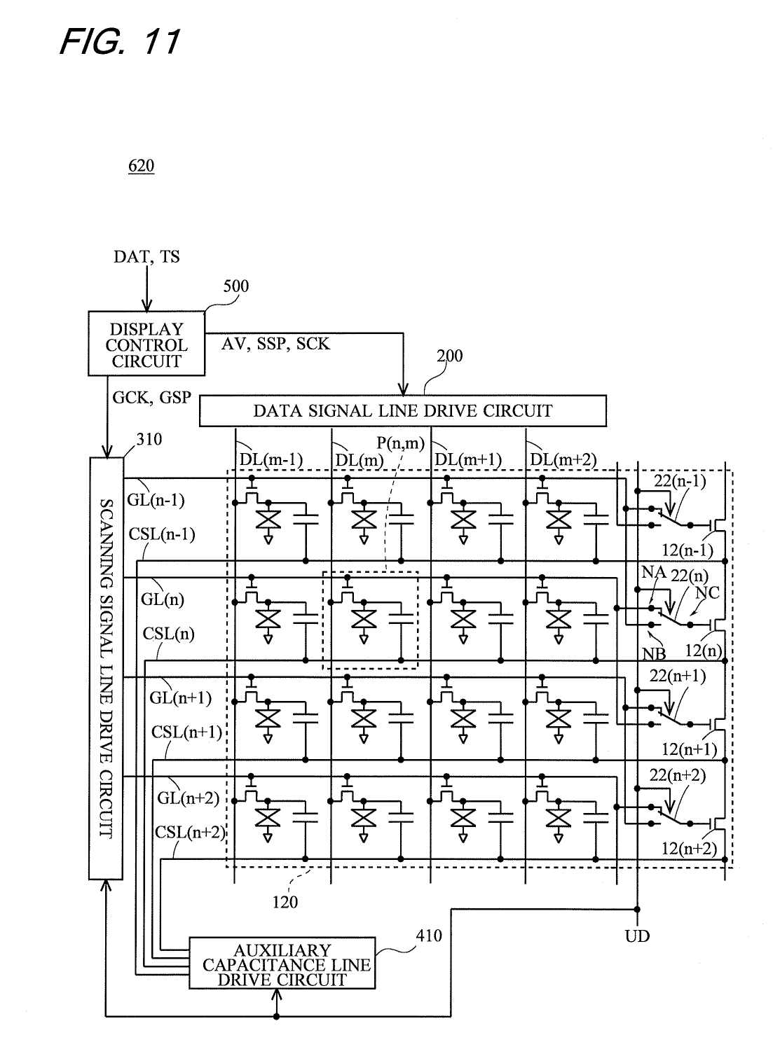

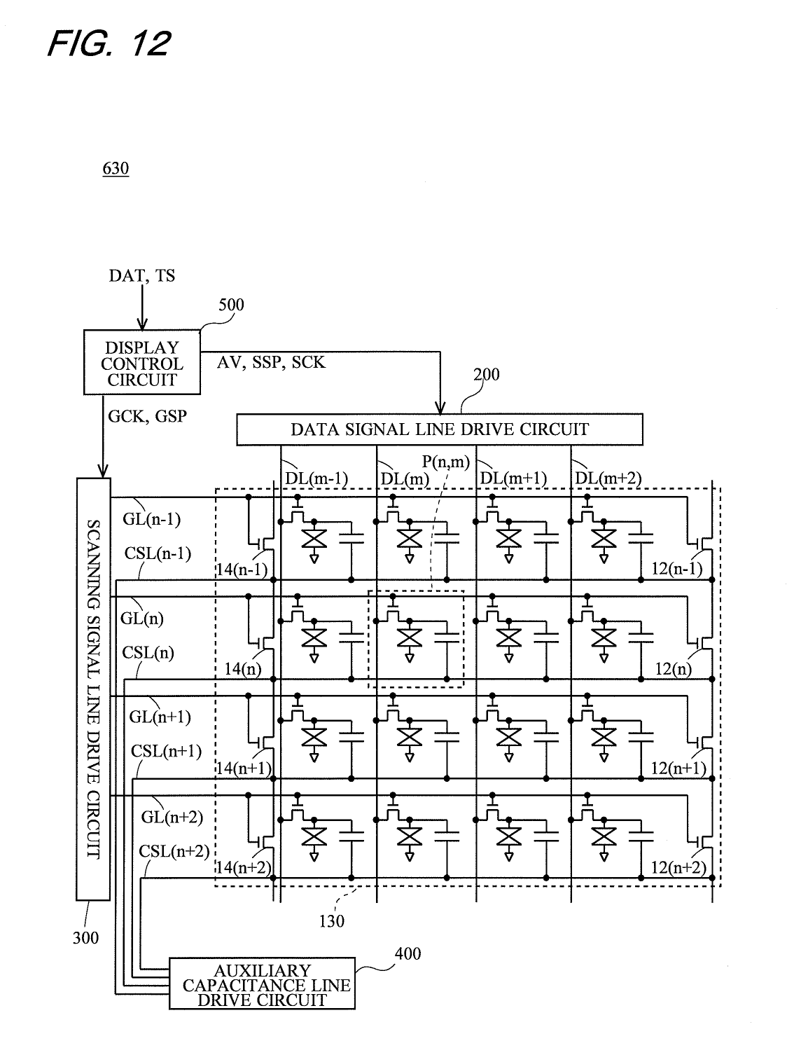

FIG. 12 is a circuit diagram illustrating an electrical configuration of a liquid crystal display device 630 according to a fourth embodiment of the present invention. The liquid crystal display device 630 of the embodiment has a configuration similar to that of the liquid crystal display device 600 of the first embodiment except that a display panel 130 is provided in place of the display panel 100. The same reference numerals are designated to the same components as those of the first embodiment in the components of the embodiment and their description will not be repeated.

### 4.2 Configuration of Display Panel

The display panel 130 in the embodiment is obtained by adding, to the display panel 100 in the first embodiment, input-end-side TFTs 14(1) to 14(N) (hereinbelow, called “input-end-side TFTs 14” when they are not distinguished from one another) as input-end-side switching elements provided in correspondence with the scanning signal lines GL(1) to GL(N), respectively. Auxiliary capacitance lines CSL adjacent to each other are connected to each other on their input-end-side via the input-end-side TFT 14. For example, auxiliary capacitance lines CSL(n−1) and CSL(n) are connected to each other on their input-end-side via an input-end-side TFT 14(n). As described above, in the embodiment, the auxiliary capacitance lines CSL adjacent to each other are connected to each other not only via the output-end-side TFTs 12 but also via the input-end-side TFTs 14.

The gate electrode as a control terminal of each of the input-end-side TFTs 14 is connected to a corresponding scanning signal line GL, the source electrode as one of conduction terminals of each input-end-side TFT 14 is connected to the auxiliary capacitance line CSL disposed along the corresponding scanning signal line GL, and the drain electrode as the other end of each input-end-side TFT 14 is connected to the auxiliary capacitance line CSL disposed along a scanning signal line preceding to the corresponding scanning signal line GL in the first direction. For example, the gate electrode of an input-end-side TFTs 14(n) is connected to a scanning signal line GL(n), the source electrode is connected to an auxiliary capacitance line CSL(n) disposed along the scanning signal line GL(n), and the drain electrode is connected to an auxiliary capacitance line CSL(n−1) disposed along a scanning signal line GL(n−1) preceding to the scanning signal line GL(n) in the first direction.

Each of the input-end-side TFTs 14 is controlled to enter the conduction state when the scanning signal line GL connected to the gate electrode is in a selection state and to enter the blocking state when the scanning signal line GL is in a non-selection state. For example, an input-end-side TFT 14(n) is controlled to enter the conduction state when a scanning signal line GL(n) connected to the gate electrode is in a selection state and to enter the blocking state when the scanning signal line GL(n) is in a non-selection state.

### 4.3 Operation

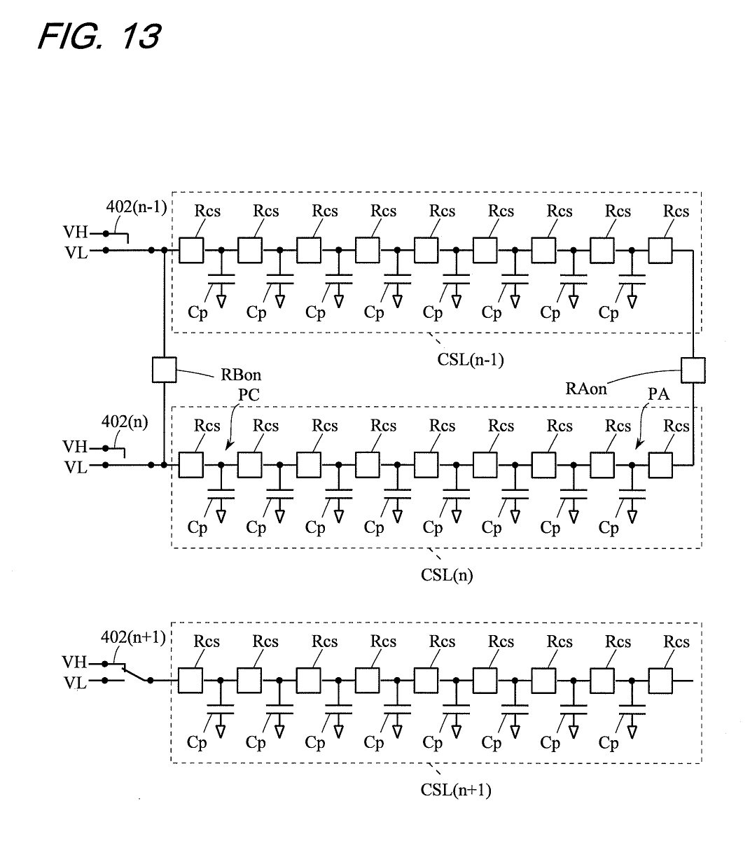

When the scanning signal line GL(n) is in a selection state and the pixel TFTs 101 connected to the scanning signal line GL(n) enter a conduction state, a positive potential VdA as a data signal from the data signal line DL(m) is given to a pixel electrode, and the output-end-side TFT 12(n) and the input-end-side TFT 14(n) enter the conduction state. When the output-end-side TFT 12(n) and the input-end-side TFT 14(n) enter the conduction state, an auxiliary capacitance line CSL(n) disposed along the scanning signal line GL(n) which is in the selection state and an auxiliary capacitance line CSL(n−1) disposed along a scanning signal line GL(n−1) preceding to the scanning signal line GL(n) in the first direction are connected to each other. The auxiliary capacitance lines CSL(n−1) to CSL(n+1) at this time are expressed by equivalent circuits made by wiring resistors Rcs and parasitic capacitances Cp illustrated in FIG. 13. The auxiliary capacitance lines CSL(n−1) and CSL(n) are connected to each other via the output-end-side TFT 12(n) (the on resistor RAon) and the input-end-side TFT 14(n) (the on resistor RBon) which are in the conduction state.

In the first embodiment, there are two final charging/discharging destinations for converging the potential fluctuation ΔV occurring in PA, so that the impedance seen from PA is seemingly reduced to almost the half of that in the conventional device. However, as described above, with distance from PA toward the direction where the potential switch 402(n) is connected, the reduction ratio of the apparent impedance becomes lower. In a part close to the input end expressed by PC in FIG. 13 (hereinbelow, simply called “PC”), the reduction ratio of apparent impedance is particularly low. On the other hand, in the embodiment, the auxiliary capacitance lines CSL(n−1) and CSL(n) are connected to each other via the input-end-side TFT 14(n) (the on resistance RBon), so that not only the impedance seen from PA but also the impedance seen from PC seemingly become about the half of the impedance in the conventional device (the time constant becomes about the half). Further, the apparent impedance from PC to PA is also reduced as compared with that in the first embodiment.

### 4.4 Effects

In the embodiment, regardless of the position where the potential fluctuation ΔV in the auxiliary capacitance line CSL(n) occurs, the apparent impedance in the auxiliary capacitance line CSL(n) is reduced sufficiently as compared with that in the conventional device. Consequently, regardless of a position where the potential fluctuation ΔV in the auxiliary capacitance line CSL(n) occurs, time Tret until the potential of the auxiliary capacitance line CSL(n) fluctuated at the time of writing a data signal recovers to the original potential becomes sufficiently shorter than that in the conventional technique. To realize the embodiment, it is sufficient to add a TFT on the input end side of each scanning signal line GL in the first embodiment. Further, it is unnecessary to separately use a signal for controlling the input-end-side TFT 14. Therefore, a lateral crosstalk can be reliably suppressed with the simple configuration.

To sufficiently suppress a potential fluctuation in the auxiliary capacitance line CSL(1), a dummy auxiliary capacitance line CSL(0) may be provided at an anterior stage of the auxiliary capacitance line CSL(1). In this case, to the auxiliary capacitance line CSL(0), the drain electrode of the output-end-side TFT 12(1) and the drain electrode of the input-end-side TFT 14(1) are connected.

### 5. Others

Preferably, the output-end-side TFTs 12 and the input-end-side TFTs 14 are formed integrally on the TFT substrate of the display panel 100. Although the output-end-side TFTs 12 and the input-end-side TFTs 14 are controlled by the potentials of the corresponding scanning signal lines GL in each of the foregoing embodiments, the present invention is not limited to the above but the control may be performed by another signal.

The input-end-side TFTs 14(1) to 14(N) may be added to the liquid crystal display device of the second or third embodiment. With the arrangement, a lateral crosstalk can be suppressed more reliably.

In the foregoing embodiments, two kinds of potentials of the low potential VH and the high potential VH are used as potentials applied to the auxiliary capacitance line. However, three or more kinds of potentials may be used. In this case, preferably, when the scanning signal line GL is in a selection state, the potentials of two auxiliary capacitance lines CSL connected to each other via the output-end-side TFT 12 or the input-end-side TFT 14 which is in the conduction state are equal to each other.

Although the example of performing display in the normally black mode is employed in the above description, also in the case of performing display in a normally white mode, effects similar to those of each of the foregoing embodiments can be obtained.

The present invention can be variously modified and executed without departing from the gist of the present invention.

As described above, the present invention can provide a display device in which a lateral crosstalk can be suppressed with a simple configuration.

### INDUSTRIAL APPLICABILITY

The present invention can be applied to an active matrix-type display device using a switching element such as a thin film transistor.

### DESCRIPTION OF REFERENCE CHARACTERS

12(1) to 12(N): OUTPUT-END-SIDE TFT (OUTPUT-END-SIDE SWITCHING ELEMENT)
14(1) to 14(N): INPUT-END-SIDE TFT (INPUT-END-SIDE SWITCHING ELEMENT)
22(1) to 22(N): SCANNING SIGNAL LINE CHANGE-OVER SWITCHE
100, 110, 120, 130, 190: DISPLAY PANEL
101: PIXEL TFT (PIXEL SWITCHING ELEMENT)
200: DATA SIGNAL LINE DRIVE CIRCUIT
300, 310: SCANNING SIGNAL LINE DRIVE CIRCUIT
400, 410: AUXILIARY CAPACITANCE LINE DRIVE CIRCUIT
500: DISPLAY CONTROL CIRCUIT
600, 610, 620, 630, 690: LIQUID CRYSTAL DISPLAY DEVICE
CSL(1) to CSL(N): AUXILIARY CAPACITANCE LINE
DL(1) to DL(M): DATA SIGNAL LINE
GL(1) to GL(N): SCANNING SIGNAL LINE

1. A display device comprising:
a plurality of data signal lines to which a plurality of data signals representing an image to be displayed are applied, respectively;
scanning signal lines crossing the plurality of data signal lines and selectively driven by applying a plurality of scanning signals, respectively;
a plurality of pixel circuits disposed in a matrix in correspondence with the respective intersections of the plurality of data signal lines and the plurality of scanning signal lines;
a plurality of auxiliary capacitance lines disposed along the plurality of scanning signal lines, respectively;
an auxiliary capacitance line drive circuit for applying a plurality of auxiliary capacitance signals for driving the plurality of auxiliary capacitance lines independently of one another to the plurality of auxiliary capacitance lines, respectively; and
an output-end-side switching element provided on an output end side of each of the scanning signal lines,
wherein each of the pixel circuits includes
a pixel switching element which enters a conduction state when the scanning signal line passing a corresponding intersection is in a selection state and enters a blocking state when the scanning signal line is in a non-selection state,
a pixel electrode connected to a data signal line passing the corresponding intersection via the pixel switching element,
a common electrode provided commonly to the plurality of pixel circuits, and
an auxiliary capacitance formed between the pixel electrode and an auxiliary capacitance line disposed along a scanning signal line passing the corresponding intersection,
after the scanning signal line is switched from a selection state to a non-selection state, the auxiliary capacitance line drive circuit changes a potential of an auxiliary capacitance signal to be applied to an auxiliary capacitance line disposed along the scanning signal line,
an auxiliary capacitance line disposed along a scanning signal line corresponding to each of output-end-side switching elements and an auxiliary capacitance line disposed along a scanning signal line preceding to the scanning signal line in a scanning direction in the plurality of scanning signal lines are connected to each other via said each of output-end-side switching elements on an output end side, and
each of output-end-side switching elements is controlled to enter a conduction state when a scanning signal line corresponding to said each of output-end-side switching elements is in the selection state and to enter a blocking state when the scanning signal line is in the non-selection state in accordance with a predetermined signal.

2. The display device according to claim 1, wherein the polarity of the plurality of data signals inverts every horizontal period, and
auxiliary capacitance signals applied to auxiliary capacitance lines connected to each other via each of output-end-side switching elements have a same potential when said each of output-end-side switching elements is in a conduction state.

3. The display device according to claim 2, wherein a control terminal of each output-end-side switching element is connected to a corresponding scanning signal line,
one of conduction terminals of each output-end-side switching element is connected to an auxiliary capacitance line disposed along the corresponding scanning signal line, and
the other conduction terminal of each output-end-side switching element is connected to an auxiliary capacitance line disposed along a scanning signal line preceding to the corresponding scanning signal line in a scanning direction of the plurality of scanning signal lines.

4. The display device according to claim 2, wherein the scanning direction of the plurality of scanning signal lines can be switched between a first direction and a second direction as a direction opposite to the first direction.

5. The display device according to claim 4, wherein a control terminal of each output-end-side switching element is selectively connected to a corresponding scanning signal line or a scanning signal line preceding to the corresponding scanning signal line in the first direction,
one of conduction terminals of each output-end-side switching element is connected to an auxiliary capacitance line disposed along a corresponding scanning signal line, and
the other conduction terminal of each output-end-side switching element is connected to an auxiliary capacitance line disposed along the scanning signal line preceding to the corresponding scanning signal line in the first direction.

6. The display device according to claim 5, further comprising a change-over switch provided in correspondence with each scanning signal line,
wherein one of switching terminals of each change-over switch is connected to a corresponding scanning signal line,
the other switching terminal of each change-over switch is connected to a scanning signal line preceding to the corresponding scanning signal line in the first direction,
a common terminal of each change-over switch is connected to a control terminal of an output-end-side switching element provided on the output-end-side of the corresponding scanning signal line, and
each change-over switch is controlled to select the one of the switching terminals when the scanning direction of the plurality of scanning signal lines is the first direction and to select the other switching terminal when the scanning direction of the plurality of scanning signal lines is the second direction.

7. The display device according to claim 2, further comprising an input-end-side switching element provided on an input end side of each scanning signal line,
wherein an auxiliary capacitance line disposed along a scanning signal line corresponding to each of input-end-side switching elements and an auxiliary capacitance line disposed along a scanning signal line preceding to the scanning signal line in a scanning direction of the plurality of scanning signal lines are connected to each other via said each of input-end-side switching elements on an input end side.
